(19) United States
(12) Patent Application Publication
(10) Pub. No.: US 2024/0320693 A1
(43) Pub. Date: Sep. 26, 2024

(54) SYSTEM FOR MANAGING VENDOR RELATIONSHIPS IN A CO-SELLER NETWORK

(71) Applicant: Harvey Keith Spivey, SR., Brentwood, TN (US)

(72) Inventor: Harvey Keith Spivey, SR., Brentwood, TN (US)

(21) Appl. No.: 18/124,555

(22) Filed: Mar. 21, 2023

(51) Int. Cl. G06Q 30/0201; G06Q 30/01

(52) U.S. Cl. CPC G06Q 30/0201; G06Q 30/01

(57) ABSTRACT

Exemplary data processing systems and computer implemented methods are disclosed for managing vendor relationships in a co-seller network. Exemplary systems and methods receive, from a first co-seller, a first customer identifier that identifies a customer served by the first co-seller; receive, from the first co-seller, a first salesperson identifier that identifies a first salesperson of the first co-seller for the customer; receive, from a second co-seller, a second customer identifier that identifies the customer as being served by the second co-seller; receive, from the second co-seller, a second salesperson identifier that identifies a second salesperson of the second co-seller for the customer; and notify the first salesperson that the first salesperson and the second salesperson have the customer in common in dependence upon the first customer identifier, the first salesperson identifier, the second customer identifier, and the second salesperson identifier.

### BACKGROUND OF THE INVENTION

The field of the invention is data processing systems, or, more specifically, systems for managing vendor relationships in a co-seller network. In today's business landscape, organizations often rely on a network of vendors to expand their reach and increase revenue. This co-seller network allows companies to leverage the expertise and resources of multiple vendors to sell their products or services to a broader audience. However, managing vendor relationships in a co-seller network can be a challenging task, as it requires collaboration and coordination among multiple parties.

Traditional methods of managing vendor relationships involve manual processes, such as phone calls, emails, and spreadsheets, which can be time-consuming and prone to errors. These methods also lack visibility into the overall performance of the co-seller network, making it difficult to identify areas of improvement.

To address these challenges, companies have started to adopt software tools and systems that can automate the management of vendor relationships. These tools allow organizations to track the performance of each vendor in the co-seller network and provide real-time data on sales and revenue generated. They also offer features such as collaboration tools, inventory management, and order tracking, which enable vendors to work together more effectively.

Sales among co-sellers to potential customers, however, require people to people interactions to coordinate and close deals. Because of the high turnover in these sales representative positions, information regarding the contact persons at the various co-sellers and customers often becomes stale and inaccurate. When a new salesperson is onboarded for one of these co-sellers, often that person spends a significant amount of time tracking down that salesperson's counterparties at other co-sellers or customers so that salesperson knows who to coordinate with to get deals closed.

Existing solutions for managing vendor relationships in a co-seller network have not improved the ability of sales representatives and teams for a vendor to easily connect with counterparties at other co-sellers or customers. Salespeople needs a system that is self-healing when information becomes stale, when old co-selling partners are no longer part of a vendor's network, or new co-selling partners become available. Current approaches involve capturing this data in Customer Relationship Management (CRM) systems and attempting to integrate the CRM data across co-seller companies. This top-down monolithic approach is expensive, laborious, and brittle. Information quickly becomes stale as these current systems cannot keep pace with the turnover that occurs in a co-selling ecosystem. Presently, a need exists for a bottom-up, grass-roots network that connects co-selling companies at a salesperson level and is customer centric.

### SUMMARY OF THE INVENTION

Data processing systems and computer implemented methods are generally disclosed for managing vendor relationships in a co-seller network according to the present invention. Such systems include one or more processing units and a physical network interface coupled to the one or more processing units. Such systems also include a non-volatile memory coupled to the one or more processing units, the non-volatile memory containing a data structure and instructions. The one or more processing units are configured to cause execution of the instructions for carrying out: receiving, from a first co-seller, a first customer identifier that identifies a customer served by the first co-seller; receiving, from the first co-seller, a first salesperson identifier that identifies a first salesperson of the first co-seller for the customer; receiving, from a second co-seller, a second customer identifier that identifies the customer as being served by the second co-seller; receiving, from the second co-seller, a second salesperson identifier that identifies a second salesperson of the second co-seller for the customer; and notifying the first salesperson that the first salesperson and the second salesperson have the customer in common in dependence upon the first customer identifier, the first salesperson identifier, the second customer identifier, and the second salesperson identifier.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for managing vendor relationships in a co-seller network according to embodiments of the present invention.

FIG. 2 sets forth a block diagram of automated computing machinery comprising an example of a data processing system useful in systems for managing vendor relationships in a co-seller network according to embodiments of the present invention.

FIG. 3 sets forth a flow chart illustrating an exemplary method for managing vendor relationships in a co-seller network according to embodiments of the present invention.

FIG. 4 sets forth a flow chart illustrating another exemplary method for managing vendor relationships in a co-seller network according to embodiments of the present invention.

FIG. 5 sets forth a flow chart illustrating another exemplary method for managing vendor relationships in a co-seller network according to embodiments of the present invention.

FIG. 6 sets forth a flow chart illustrating another exemplary method for managing vendor relationships in a co-seller network according to embodiments of the present invention.

FIG. 7 sets forth a flow chart illustrating another exemplary method for managing vendor relationships in a co-seller network according to embodiments of the present invention.

FIG. 8 sets forth a flow chart illustrating another exemplary method for managing vendor relationships in a co-seller network according to embodiments of the present invention.

FIG. 9 sets forth a flow chart illustrating another exemplary method for managing vendor relationships in a co-seller network according to embodiments of the present invention.

FIG. 10 sets forth a flow chart illustrating another exemplary method for managing vendor relationships in a co-seller network according to embodiments of the present invention.

FIG. 11 sets forth a flow chart illustrating another exemplary method for managing vendor relationships in a co-seller network according to embodiments of the present invention.

FIG. 12 sets forth a flow chart illustrating an additional exemplary method for managing vendor relationships in a co-seller network according to embodiments of the present invention.

FIG. 13 sets forth a flow chart illustrating an additional exemplary method for managing vendor relationships in a co-seller network according to embodiments of the present invention.

FIG. 14 sets forth a flow chart illustrating an additional exemplary method for managing vendor relationships in a co-seller network according to embodiments of the present invention.

FIG. 15 sets forth a flow chart illustrating an additional exemplary method for managing vendor relationships in a co-seller network according to embodiments of the present invention.

FIG. 16 sets forth a flow chart illustrating an additional exemplary method for managing vendor relationships in a co-seller network according to embodiments of the present invention.

FIG. 17 sets forth a flow chart illustrating an additional exemplary method for managing vendor relationships in a co-seller network according to embodiments of the present invention.

FIG. 18 sets forth a flow chart illustrating an additional exemplary method for managing vendor relationships in a co-seller network according to embodiments of the present invention.

FIG. 19 sets forth a flow chart illustrating an additional exemplary method for managing vendor relationships in a co-seller network according to embodiments of the present invention.

FIG. 20 sets forth a flow chart illustrating an additional exemplary method for managing vendor relationships in a co-seller network according to embodiments of the present invention.

### DETAILED DESCRIPTION OF EXEMPLARY EMBODIMENTS

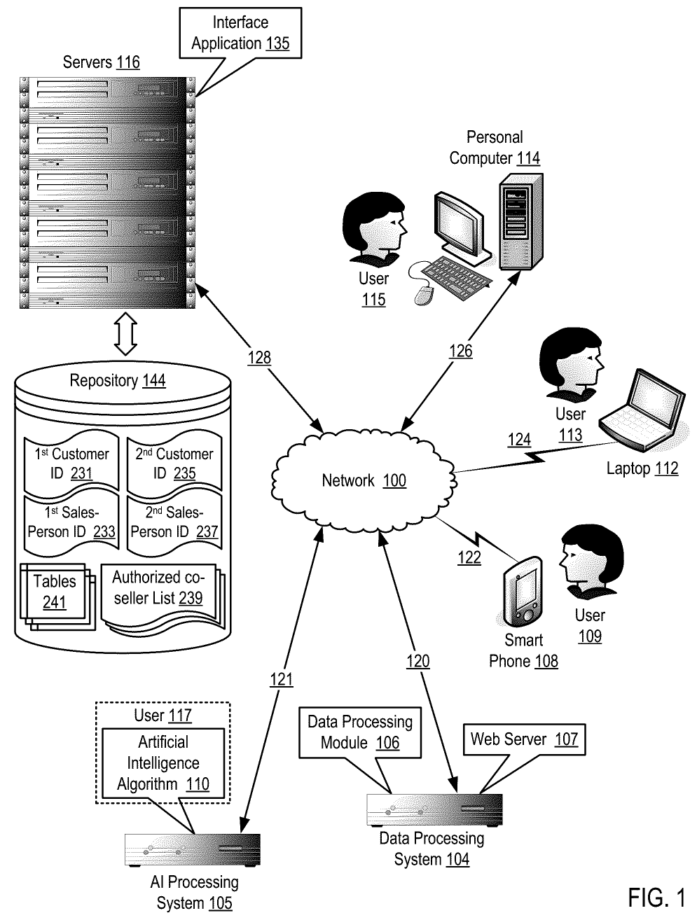

Exemplary systems for managing vendor relationships in a co-seller network according to embodiments of the present invention are described with reference to the accompanying drawings, beginning with FIG. 1. FIG. 1 sets forth a network diagram illustrating an exemplary system for managing vendor relationships in a co-seller network according to embodiments of the present invention.

The co-seller network is a collection of vendors working together to provide a customer with complete business solution of equipment, software, and/or services. Typically, no single vendor has the capability or resources to provide a complete business solution on its own. Each vendor, therefore, strategically partners with other vendors to provide as complete of an offering as is possible to meet customer needs or requirements. The typical co-sellers are members of the supply chain like Original Equipment Manufacturers (OEM's), Distributors (Disti's), and Value Added Resellers (VAR's), Systems Integrators (SI's), and consultants, etc. However, this network can be useful in collaboration across any industry or market like healthcare, team sports, or anywhere a group of service providers need to collaborate around a common consumer (doctors to a patient, trainers to an athlete, etc).

While the strategic partnerships between vendors may occur or be decided at the company level, the implementation of these strategic partnerships occur between sales representatives as they work together with their teams to provide solutions for their mutual customer. In order to collaborate for the benefit of their common customers, these sales representatives across vendors have to be able to contact one another and keep up with the staffing changes each vendor in the partnership inevitably experiences. As a vendor adds to, removes from, or moves sales representatives around in the company, the contacts within each vendor in a strategic partnership shift or change. The sales representatives remaining in the co-seller network may use systems for managing vendor relationships in a co-seller network according to embodiments of the present invention to quickly form relationships among the new set of sales representatives for a particular strategic alliance within network of vendors. Sales representatives remaining in the co-seller network may then quickly find their counterparties that replaced old contacts at other co-sellers with which their company has strategic partnerships. Moreover, using systems for managing vendor relationships in a co-seller network according to embodiments of the present invention, a new salesperson can more easily locate the person who previously held that position. By leveraging the institutional knowledge provided by the prior person, the new salesperson can dramatically reduce the amount of time required to learn information that may be vital to the vendor's overall success with co-sellers and customers. Such information may include industry contacts or specialize information regarding the performance of a particular vendor's or co-seller's product or service offering.

The exemplary system of FIG. 1 includes a data processing system (104) connected to various other devices via network (100). A data processing system generally refers to automated computing machinery. The data processing system (104) of FIG. 1 useful in managing vendor relationships in a co-seller network according to embodiments of the present invention may be configured in a variety of form factors or implemented using a variety of technologies. Some data processing systems may be implemented using single-purpose computing machinery, such as special-purpose computers programmed only for the task of data processing for identifying the ability of users to forecast popularity of various content items according to embodiments of the present invention. Other data processing systems may be implemented using multi-purpose computing machinery, such as general purpose computers programmed for a variety of data processing functions in addition to identifying the ability of users to forecast popularity of various content items according to embodiments of the present invention. These multi-purpose computing devices may be implemented as portable computers, laptops, personal digital assistants, tablet computing devices, multi-functional portable phones, or the like.

In the example of FIG. 1, the data processing system (104) includes at least one processor, at least one memory, and at least one transceiver, all operatively connected together, typically through a communications bus. The transceiver is a network transmitter and receiver that connects the data processing system (104) to the network (100) through a wired connection (120). The transceiver may use a variety of technologies, alone or in combination, to establish wired connection (120) with network (100) including, for example, those technologies described by Institute of Electrical and Electronics Engineers (IEEE) 802.3 Ethernet standard, SynOptics LattisNet standard, 100BaseVG standard, Telecommunications Industry Association (TIA) 100BASE-SX standard, TIA 10BASE-FL standard, G.hn standard promulgated by the ITU Telecommunication Standardization Sector, or any other wired communications technology as will occur to those of skill in the art.

Non-volatile memory included in the data processing system (104) of FIG. 1 includes a data processing module (106) and web server (107). Non-volatile memory is computer memory that can retain the stored information even when no power is being supplied to the memory. The non-volatile memory may be part of the data processing system (104) of FIG. 1 or may be a separate storage device operatively coupled to the data processing system (104). Examples of non-volatile memory include flash memory, ferroelectric RAM, magnetoresistive RAM, hard disks, magnetic tape, optical discs, and others as will occur to those of skill in the art.

The data processing module (106) of FIG. 1 is a set of computer program instructions for managing vendor relationships in a co-seller network according to embodiments of the present invention. When processing the data processing module (106) of FIG. 1, a processor may operate the data processing system (104) of FIG. 1 to: receive, from a first co-seller, a first customer identifier (231) that identifies a customer served by the first co-seller; receive, from the first co-seller, a first salesperson identifier (233) that identifies a first salesperson of the first co-seller for the customer; receive, from a second co-seller, a second customer identifier (235) that identifies the customer as being served by the second co-seller; receive, from the second co-seller, a second salesperson identifier (237) that identifies a second salesperson of the second co-seller for the customer; and notify the first salesperson that the first salesperson and the second salesperson have the customer in common in dependence upon the first customer identifier (231), the first salesperson identifier (233), the second customer identifier (235), and the second salesperson identifier (237).

The data processing system (104) of FIG. 1 may also carry out other aspects of managing vendor relationships in a co-seller network according to embodiments of the present invention. For example, the processor may further operate the data processing system (104) of FIG. 1 to: receive, from the first co-seller, an authorized co-seller list (239) that identifies other co-sellers that the first co-seller partners with to service customers; and notify the first salesperson that the first salesperson and the second salesperson have the customer in common only if the second co-seller is identified in the authorized co-seller list (239). The processor may further operate the data processing system (104) of FIG. 1 to receive, from the first co-seller, a request to add a new co-seller to the authorized co-seller list (239). The processor may also operate the data processing system (104) of FIG. 1 to receive, from the first co-seller, a request to remove a former co-seller from the authorized co-seller list (239).

In addition, the processor may further operate the data processing system (104) of FIG. 1 to: receive, from the first salesperson, the first customer identifier (231) that identifies the customer served by the first co-seller; authenticate the identity of the first salesperson; and notify the first salesperson that the first salesperson and the second salesperson have the customer in common in dependence upon authenticating the identity of the first salesperson and the first customer identifier (231). The processor may further operate the data processing system (104) of FIG. 1 to: validate employment status of the first salesperson with the first co-seller; and publish that the first salesperson is not active with the first co-seller in dependence upon validation of the employment status of the first salesperson. In addition, the processor may also operate the data processing system (104) of FIG. 1 to receive, from the first co-seller, a supervisor identifier that identifies a supervisor at the first co-seller to which the first salesperson reports; and notify the supervisor to update salesperson information of the first co-seller for the customer in dependence upon validation of the employment status of the first salesperson and the supervisor identifier.

In addition, the processor may operate the data processing system (104) of FIG. 1 to: receive, from the first co-seller, a new salesperson identifier that identifies a new salesperson of the first co-seller for the customer; and notify the second salesperson that the new salesperson and the second salesperson have the customer in common in dependence upon the first customer identifier (231), the new salesperson identifier, the second customer identifier (235), and the second salesperson identifier (237). The processor may also operate the data processing system (104) of FIG. 1 to: receive, from the first co-seller, a new salesperson identifier that identifies a new salesperson of the first co-seller for the customer; and notify the new salesperson that the new salesperson and the first salesperson have the customer in common in dependence upon the first customer identifier (231), the first salesperson identifier (233), and the new salesperson identifier. The processor may operate the data processing system (104) of FIG. 1 to: receive, from the first co-seller, a new salesperson identifier that identifies a new salesperson of the first co-seller for the customer; and notify the customer of the new salesperson of the first co-seller in dependence upon the new salesperson identifier.

In addition, the processor may operate the data processing system (104) of FIG. 1 to: receive, from the customer, a customer request for contact information of the first salesperson of the first co-seller that services the customer; and notify the customer of the contact information of the first salesperson. The processor may further operate the data processing system (104) of FIG. 1 to: receive, from the second co-seller, second sales team identifier that identify a second sales team of the second co-seller for the customer; and notify the first salesperson that the first salesperson and the second sales team have the customer in common in dependence upon the second sales team identifier. The processor may also operate the data processing system (104) of FIG. 1 to: receive, from the first co-seller, first sales team identifier that identifies a first sales team of the first co-seller for the customer; and notify the first salesperson of the first sales team for the customer. In addition, the processor may also operate the data processing system (104) of FIG. 1 to: receive, from the first co-seller, a first sales team identifier that identify a first sales team of the first co-seller for the customer; and notify the customer of the first sales team of the first co-seller for the customer in dependence upon the first sales team identifier. The processor may operate the data processing system (104) of FIG. 1 to: receive, from the first co-seller, a customer contact of the customer for the first co-seller; and notify the second co-seller of the customer contact of the customer in common. In addition, the processor may also operate the data processing system (104) of FIG. 1 to: receive, from the customer, a new customer contact of the customer for the first co-seller; and notify the first co-seller of the new customer contact of the customer.

Still further, the processor may also operate the data processing system (104) of FIG. 1 to: receive, from the first co-seller, a request for co-sellers with a co-seller attribute; generate a filtered co-seller list in dependence upon the co-seller attribute; and provide the first co-seller with the filtered co-seller list. The processor may also operate the data processing system (104) of FIG. 1 to: receive, from the customer, a request for co-sellers with a co-seller attribute; generate a filtered co-seller list in dependence upon the co-seller attribute; and provide the customer with the filtered co-seller list. In addition, the processor may also operate the data processing system (104) of FIG. 1 to: receive, from the first co-seller, a co-seller attribute associated with the first co-seller; and publish to other users the co-seller attribute associated with the first co-seller.

In the example of FIG. 1, servers (116) host the repository (144) of information that may be useful in systems for system for managing vendor relationships in a co-seller network according to embodiments of the present invention. The repository (144) may be implemented as a database stored locally on the servers (116) or remotely stored and accessed through a network. As the data processing system (104) of FIG. 1 receives certain information from various users of the system for managing vendor relationships in a co-seller network according to embodiments of the present invention, the data processing system (104) may store that information the data repository (144). For example, in FIG. 1, the first customer identifier (231), the first salesperson identifier (233), the second customer identifier (235), the second salesperson identifier (237), and the authorized co-seller list (239) are all stored in the repository (144). The repository (144) of FIG. 1 also includes various tables (241) for storing other information processed by the data processing system (104) such as, for example, co-seller identifiers, contact information, employment status, supervisor identifier, salesperson information, new salesperson identifier, sales team identifier, customer contact information, new customer contact information, co-seller attribute, filtered co-seller list, among others. While the first customer identifier (231), the first salesperson identifier (233), the second customer identifier (235), the second salesperson identifier (237), and the authorized co-seller list (239) are all shown logically separate from the tables (241) in FIG. 1, one of ordinary skill in the art will recognize that such information may also be stored in the tables (241). Moreover, those of skill in the art will recognize a variety of data structures could be used to store the information in the repository (144) such as, for example, arrays, linked lists, tree structures, stacks, queues, and so on. In addition, all of the information stored in the repository (144) that is utilized by the data processing system (104) may also be stored in the local memory of the data processing system (104).

The information stored in repository (144) of FIG. 1 is operatively coupled to an interface application (135). The interface application (135) may be operatively coupled to such an exemplary repository through an application programming interface (‘API’) exposed by a database management system (‘DBMS’) such as, for example, an API provided by the Open Database Connectivity (‘ODBC’) specification, the Java database connectivity (‘JDBC’) specification, and so on.

The data processing system (104) and the users (109, 113, 155, 117) of FIG. 1, in turn, access the content items (130) through interface application (135). The interface application (135) of FIG. 1 may provide an interface description of the web services publication interface by publishing the web services publication interface description in a Universal Description, Discovery and Integration (‘UDDI’) registry hosted by a UDDI server. A UDDI registry is a platform-independent. XML-based registry for organizations worldwide to list themselves on the Internet. UDDI is an open industry initiative promulgated by the Organization for the Advancement of Structured Information Standards (‘OASIS’), enabling organizations to publish service listings, discover each other, and define how the services or software applications interact over the Internet. The UDDI registry is designed to be interrogated by SOAP messages and to provide access to Web Services Description Language (‘WSDL’) documents describing the protocol bindings and message formats required to interact with a web service listed in the UDDI registry. In this manner, the data processing system (104) of FIG. 1 may retrieve the web services publication interface description for the content items (130) from the UDDI registry on servers (116). The term ‘SOAP’ refers to a protocol promulgated by the World Wide Web Consortium (‘W3C’) for exchanging XML-based messages over computer networks, typically using Hypertext Transfer Protocol (‘HTTP’) or Secure HTTP (‘HTTPS’).

In the example of FIG. 1, the web services publication interface description utilized by the interface application (135) of FIG. 1 may be implemented as a Web Services Description Language (‘WSDL’) document. The WSDL specification provides a model for describing a web service's interface as collections of network endpoints, or ports. A port is defined by associating a network address with a reusable binding, and a collection of ports define a service. Messages in a WSDL document are abstract descriptions of the data being exchanged, and port types are abstract collections of supported operations. The concrete protocol and data format specifications for a particular port type constitutes a reusable binding, where the messages and operations are then bound to a concrete network protocol and message format. In such a manner, the data processing system (104) or other similar systems may utilize the web services publication interface description to invoke the publication service provided by the interface application (135), typically by exchanging SOAP messages with the interface application (135). Of course, protocols other than SOAP may also be implemented such as, for example, REST message protocols, JavaScript Object Notation (JSON) protocols, and the like. The interface application (135) of FIG. 1 may be implemented using Java, C, C++, C#, Perl, Python, or any other programming language as will occur to those of skill in the art.

In FIG. 1, the users include human users (109, 113, 115), but also includes a machine user (117). While human users (109, 113, 115) may use certain biological data processing mechanisms or impulses to interact with systems for managing vendor relationships in a co-seller network according to embodiments of the present invention, machine user (117) may utilize an artificial intelligence algorithm (110) to interact with such systems for managing vendor relationships in a co-seller network according to embodiments of the present invention. Such an algorithm (110) may analyze how vendors and customers utilize the system to manage vendor relationships in a co-seller network and make recommendations to sales representatives in the co-seller network regarding connections that might be useful based on prior patterns or based on information connections that the algorithm can glean from other data. For example, the algorithm (110) may analyze a press release from a customer that signed a contract with a vendor and notify the sales representative of a co-seller who often works with that vendor that the sales representative should connect with the sales representative for that vendor to see if the co-seller's products or services would also benefit the customer. Algorithms useful in systems for managing vendor relationships in a co-seller network according to embodiments of the present invention may include such algorithms based on the OpenAI platform, the HuggingFace platform, Cohere.AI platform as well as others as will occur to those of skill in the art.

The web server (107) of FIG. 1 is software that serves web pages to and responds to requests from clients on the World Wide Web. A web server may process incoming network requests over Hypertext Transfer Protocol (HTTP) and several other related protocols. Clients typically include web browsers such as, for example, Google Chrome, Microsoft Edge, Internet Explorer, Safari, Mozilla Firefox, and well as others, but may also include any software programed to send requests using transfer protocols such as HTTP. The web server (107) of FIG. 1 accesses, processes, and delivers web pages to various clients operating on devices (108, 112, 114) connected via the network (100). The webpages delivered are most frequently HTML documents, which may include text, audio, images, video, style sheets, and scripts, but other formats will occur to those of skill in the art may also be used.

In the example of FIG. 1, the web server (107) is the interface through which users (109, 113, 115, and 117) interact with data processing module (106). Human users (109, 113, 115) of FIG. 1, may interact with data processing module (106) through webpages served up by web server (107). Machine user (117) in the example of FIG. 1 may interact with data processing module (106) through an application programming interface (API) exposed by the web server (107) to the network (100). This API may be implemented using Representational State Transfer (REST), Simple Object Access Protocol (SOAP), Rich client platform (RCP), or other architectures as will occur to those of skill in the art.

For example, the human users (109, 113, 115) of FIG. 1 may be salespeople that work with vendors in a co-seller network. Those users (109, 113, 115) interact with data processing module (106) to upload information pertinent to them about the co-seller network to which they belong. Those users (109, 113, 115) may upload through the web interface provided by the web server (107) their contact information (e.g., email, phone numbers, address, company, company division, supervisor contact information), customer information for customers whose accounts they manage, sales teams they are part of, forwarding information for when they leave the company, contact information for counterparts at other vendors with whom they work, contact information for their contacts at each of their customers, and so on. This information may be uploaded by inputting the data into fields on a user interface, retrieving the data from an outside CRM through an API using the sale person's credentials provided to the data processing module (106) through the web server (107), uploading a comma separated value (CSV) file to the data processing system (104), or other ways as will occur to those of skill in the art. Machine user (117), in turn, may make a request through a REST API exposed by web server (107) that provides data processing module (106) this same type of information using an XML file, CSV file, or some other data structure. The machine user (117) may make a request through a REST API exposed by web server (107) that requesting various information from the data processing module (106) so that the artificial intelligence algorithm (110) can analyze the state of the information about and the structure of the co-seller network to give various recommendations to participants in the co-seller network regarding ways to optimize their use of the co-seller network.

Because the data processing system (104) of FIG. 1 is connected to the network (100), the data processing system (104) of FIG. 1 may communicate with other devices connected to the network (100). In the example of FIG. 1, for example, smart phone (108) operated by user (109) connects to the network (100) via wireless connection (122), laptop (112) operated by user (113) connects to network (100) via wireless connection (124), personal computer (114) operated by user (115) connects to network (100) through wireline connection (126), artificial intelligence processing system (105) running artificial intelligence algorithm (110) connects to network (100) via wireline connection (121), and servers (116) connect to network (100) through wireline connection (128).

The wireless connections (122, 124) of Figure may be implemented using many different technologies. For example, useful technologies for with exemplary embodiments of the present invention may include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), Integrated Digital Enhanced Network (iDEN), IEEE 802.11 technology, Bluetooth, WiGig, WiMax, Iridium satellite communications technology, Globalstar satellite communications technology, or Starlink satellite communications technology.

In the example of FIG. 1, all of the servers and devices are connected together through a communications network (100), which in turn may be composed of many different networks. These different networks may be packet switched networks or circuit switched networks, or a combination thereof, and may be implemented using wired, wireless, optical, magnetic connections, or using other mediums as will occur to those of skill in the art. Typically, circuit switch networks connect to packet switch networks through gateways that provide translation between protocols used in the circuit switch network such as, for example, PSTN-V5 and protocols used in the packet switch networks such as, for example, SIP.

The packet switched networks, which may be used to implement network (100) in FIG. 1, are composed of a plurality of computers that function as data communications routers, switches, or gateways connected for data communications with packet switching protocols. Such packet switched networks may be implemented with optical connections, wireline connections, or with wireless connections or other such connections as will occur to those of skill in the art. Such a data communications network may include intranets, internets, local area data communications networks (‘LANs’), and wide area data communications networks (‘WANs’). Such packet switched networks may implement, for example:
a link layer with the Ethernet™ Protocol or the Wireless Ethernet™ Protocol,
a data communications network layer with the Internet Protocol (‘IP’),
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The circuit switched networks, which may be used to implement network (100) in FIG. 1, are composed of a plurality of devices that function as exchange components, switches, antennas, base stations components, and connected for communications in a circuit switched network. Such circuit switched networks may be implemented with optical connections, wireline connections, or with wireless connections. Such circuit switched networks may implement the V5.1 and V5.2 protocols along with other as will occur to those of skill in the art.

The arrangement of the devices (104, 105, 108, 112, 114, 116) and the network (100) making up the exemplary system illustrated in FIG. 1 are for explanation, not for limitation. Systems useful for managing vendor relationships in a co-seller network according to various embodiments of the present invention may include additional networks, servers, routers, switches, gateways, other devices, and peer-to-peer architectures or others, not shown in FIG. 1, as will occur to those of skill in the art. Networks in such data processing systems may support many protocols in addition to those noted above. Various embodiments of the present invention may be implemented on a variety of hardware platforms in addition to those illustrated in FIG. 1.

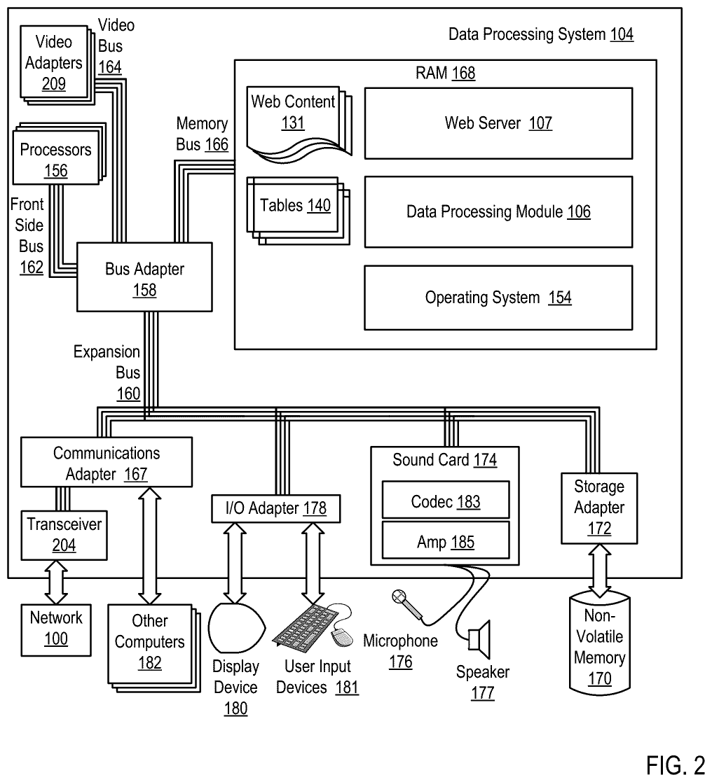

For further explanation, therefore, FIG. 2 sets forth a block diagram of automated computing machinery comprising an example of a data processing system (104) for use in an exemplary system for identifying the ability of users to forecast popularity of various content items according to embodiments of the present invention. The data processing system (104) of FIG. 2 includes at least one processor (156) or ‘CPU’ as well as random access memory (168) (‘RAM’) which is connected through a high speed memory bus (166) and bus adapter (158) to processor (156) and to other components of the data processing system (104).

Stored in RAM (168) of FIG. 2 is a data processing module (106) that is a set of computer programs for managing vendor relationships in a co-seller network according to embodiments of the present invention. The data processing module (106) of FIG. 2 operates in a manner similar to the manner described with reference to FIG. 1. In at least one exemplary configuration, the data processing module (106) of FIG. 2 instructs the processor (156) of the data processing system (104) to: receive, from a first co-seller, a first customer identifier that identifies a customer served by the first co-seller; receive, from the first co-seller, a first salesperson identifier that identifies a first salesperson of the first co-seller for the customer; receive, from a second co-seller, a second customer identifier that identifies the customer as being served by the second co-seller; receive, from the second co-seller, a second salesperson identifier that identifies a second salesperson of the second co-seller for the customer; and notify the first salesperson that the first salesperson and the second salesperson have the customer in common in dependence upon the first customer identifier, the first salesperson identifier, the second customer identifier, and the second salesperson identifier.

Also stored in RAM (168) of FIG. 2 are tables (140), web server (107), and web content (131). The tables (140) in FIG. 2 are data structures used by the data processing module (106) to store various information such as, for example, the information stored in the repository (144) of FIG. 1, along with other calculations made by the processors (156) while executing the instructions of the data processing module (106) in accordance with embodiments of the present invention. These tables (140) may be implemented as a part of a database accessible to the data processing module (106) or as part of a file structure controlled directly by the data processing module (106).

The tables (140) of FIG. 2 may be local copies of various information stored in the repository (144 on FIG. 1). The data processing system (104) would have retrieved those through the transceiver (204) that connects the data processing system (104) to the network (100).

The web server (107) of FIG. 2 serves up web content (131) based on requests received from other devices connected the network (100). The web content (131) of FIG. 2 may be implemented as web pages stored statically or created dynamically. In the example of FIG. 2, the web content (131) may be a webpage whereby a user input various information for use by the data processing module (106) or webpages for notifying users of certain output generated by the data processing module (106).

Also stored in RAM (168) is an operating system (154). Operating systems useful in systems for managing vendor relationships in a co-seller network according to embodiments of the present invention include UNIX™, Linux™, Microsoft Windows™, IBM's AIX™, IBM's i5/OS™, Google™ Android™, Google™ Chrome OS™, Apple™ Mac™ OS, and others as will occur to those of skill in the art. Operating system (154), tables (140), web server (107), web content (131), and the data processing module (106) in the example of FIG. 2 are shown in RAM (168), but many components of such software typically are stored in other secondary storage or other non-volatile memory storage, for example, on a flash drive, optical drive, disk drive, or the like.

The data processing system (104) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in a data processing system according to embodiments of the present invention include the Intel Northbridge, the Intel Memory Controller Hub, the Intel Southbridge, and the Intel I/O Controller Hub. Examples of expansion buses useful in data processing systems according to embodiments of the present invention include Peripheral Component Interconnect (‘PCI’) and PCI-Extended (‘PCI-X’) bus, as well as PCI Express (‘PCIe’) point to point expansion architectures and others.

The data processing system (104) of FIG. 2 includes storage adapter (172) coupled through expansion bus (160) and bus adapter (158) to processor (156) and other components of the data processing system (104). Storage adapter (172) connects non-volatile memory (170) to the data processing system (104). Storage adapters useful in data processing systems according to embodiments of the present invention include Integrated Drive Electronics (‘IDE’) adapters, Small Computer System Interface (‘SCSI’) adapters, Universal Serial Bus (‘USB’) and others as will occur to those of skill in the art. In addition, non-volatile computer memory may be implemented for an data processing system as an optical disk drive, electrically erasable programmable read-only memory (so-called ‘EEPROM’ or ‘Flash’ memory), RAM drives, and so on, as will occur to those of skill in the art.

The example data processing system (104) of FIG. 2 includes a sound card (174) to control input from a microphone (176) and output to a speaker (177). The sound card (174) decodes and encodes electromagnetic representations of sound between digital and analogue formats using codecs (183). The analogue electromagnetic representations of sound are amplified by the amplifier (185) configured in the sound card (174).

The example data processing system (104) of FIG. 2 includes one or more input/output (′I/O′) adapters (178). I/O adapters in data processing systems implement user-oriented input/output through, for example, software drivers and computer hardware for controlling output to display devices such as computer display device (180), as well as user input from user input devices (181) such as keyboards and mice. The example data processing system of FIG. 2 also includes a video adapter (209), which is an example of an I/O adapter specially designed for graphics processing for the data processing system (104) useful for controlling higher-end video monitors and/or video input devices. Video adapter (209) is connected to processor (156) through a high speed video bus (164), bus adapter (158), and the front side bus (162), which is also a high speed bus.

The exemplary data processing system (104) of FIG. 2 includes a communications adapter (167) for data communications with other computer (182) and for data communications with a data communications network (100) through a transceiver (204). Such data communications may be carried out serially through RS-232 connections with other computers, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for in various embodiments of the present invention include modems for wired dial-up communications, Ethernet (IEEE 802.3) adapters for wired data communications network communications, and 802.11 adapters for wireless data communications network communications. The transceiver (204) may be implemented using use a variety of technologies, alone or in combination, to establish wireline or wireless communication with network (100) including, for example, Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), Integrated Digital Enhanced Network (iDEN), IEEE 802.11 technology, Bluetooth, WiGig, WiMax, Iridium satellite communications technology, Globalstar satellite communications technology, Starlink satellite communications technology, or any other wireless communications technology as will occur to those of skill in the art.

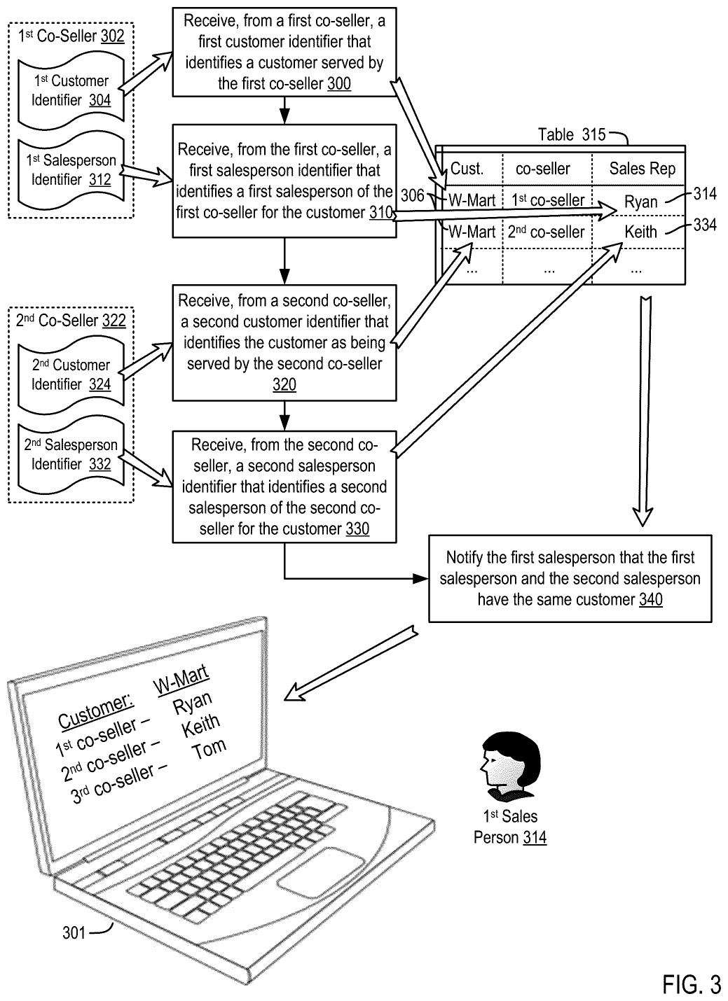

For further explanation, FIG. 3 sets forth a flow chart illustrating an exemplary method for managing vendor relationships in a co-seller network according to embodiments of the present invention. The exemplary method of FIG. 3 operates on a data processing system that includes one or more processing units, a physical network interface coupled to the one or more processing units, and a non-volatile memory coupled to the one or more processing units. The non-volatile memory contains data structures and instructions that, when executed by a processing unit, carry out the steps shown in the example of FIG. 3.

In the example of FIG. 3, a data processing unit receives (300), from a first co-seller (302), a first customer identifier (304) that identifies a customer (306) served by the first co-seller (302). The first customer identifier (304) of FIG. 1 is any information that can uniquely identify the customer that the first co-seller (302) serves. Examples of a first customer identifier (304) may include a company's name, internet domain name, federal tax identification number, some unique value assigned to the company, or some other means of uniquely identifying a customer as will occur to those of skill in the art.

The data processing unit receives (300) a first customer identifier (304) from a first co-seller (302) in FIG. 3 by providing a sales representative of the first co-seller (302) with a user interface that allows the salesperson to upload a CSV file with the identity of each of the customers of the first co-seller (302). In other embodiments, the data processing unit may receive (300) a first customer identifier (304) from a first co-seller (302) in FIG. 3 by providing a user interface for the salesperson to manually type the names of the co-seller's (302) customers into the system. Still further, in other embodiments, a data processing unit may receive (300) a first customer identifier (304) from a first co-seller (302) in FIG. 3 by accessing a list of customers from a co-seller's CRM system using API calls and credentials supplied by the sale co-seller's administrator or sales team. In the example of FIG. 3, the customer (306) is implemented as ‘W-Mart’ and upon receiving the first customer identifier (304), the data processing system stores that customer information in table (315).

In the example of FIG. 3, a data processing unit also receives (310), from the first co-seller (302), a first salesperson identifier (312) that identifies a first salesperson (314) of the first co-seller (302) for the customer (306). The first salesperson identifier (312) of FIG. 3 is any information that can uniquely identify the first salesperson (314). Example of the first salesperson identifier (312) of FIG. 3 includes the salesperson's name, social security number, email address, work cell phone number, work office phone number, unique value assigned to the salesperson (314), or any other unique identifier as will occur to those of skill in the art.

The data processing unit described with reference to FIG. 3 may receive (310) the first salesperson identifier (312) from the first co-seller (302) by providing a sales representative of the first co-seller (302) with a user interface that allows the salesperson to upload a CSV file with the identity of each salesperson and the customers to which those salespersons are assigned. In other embodiments, the data processing unit described with reference to FIG. 3 may receive (310) the first salesperson identifier (312) from the first co-seller (302) by providing a user interface for the salesperson to manually type the names of the co-seller's (302) sales representatives for each customer into the system. Still further, in other embodiments, the data processing unit described with reference to FIG. 3 may receive (310) the first salesperson identifier (312) from the first co-seller (302) by accessing a list of sales representatives from a co-seller's CRM system using API calls and credentials supplied by the sale co-seller's administrator or a member of the sales team. In the example of FIG. 3, table (315) stores information received from various co-sellers, including that the sales representative (314) of the 1st Co-seller for ‘W-Mart’ is ‘Ryan’.

In much the same manner with respect to the first co-seller, the data processing system described with reference to FIG. 3 includes receives (320), from a second co-seller (322), a second customer identifier (324) that identifies the customer (306) as being served by the second co-seller (322), and the data processing system receives (330), from the second co-seller (322), a second salesperson identifier (332) that identifies a second salesperson (334) of the second co-seller (322) for the customer (306). In the example of FIG. 3, table (315) stores information received from the second co-seller (322) including that the sales representative of the 2^{nd} Co-seller for ‘W-Mart’ is ‘Keith’.

In the example of FIG. 3, the data processing system notifies (340) the first salesperson (314) that the first salesperson (314) and the second salesperson (334) have the customer (306) in common in dependence upon the first customer identifier (304), the first salesperson identifier (312), the second customer identifier (324), and the second salesperson identifier (332). The data processing system described with reference to FIG. 3 may notify (340) the first salesperson (314) that the first salesperson (314) and the second salesperson (334) have the customer (306) in common by identifying all of the rows in table (315) pertaining to a particular customer such as, for example, ‘W-Mart’ using the customer identifier for that company. The data processing system of FIG. 3 may compare the customer identifier for ‘W-Mart’ with the entries for the customer identifier field in table (315) and create a list of matching entries. From this list of entries that match the relevant customer identifier, the data processing system described with reference to FIG. 3 would then look up the names of the sales representatives for that customer in a sales representative table using the sale person identifiers in those rows that match the customer identifier for the desired customer.

The data processing system described with reference to FIG. 3 may notify (340) the first salesperson (314) that the first salesperson (314) and the second salesperson (334) have the customer (306) in common by generating a webpage that displays the salespersons of various vendors assigned to a particular customer and sending that webpage to be rendered on the user interface of a computer of the first salesperson (314). For example, in FIG. 3, the data processing system generates a table on a webpage that displays on laptop (301) to the first salesperson (314) the various sales representatives for different co-sellers where ‘W-Mart’ is the customer. In FIG. 3, the laptop (301) is used to show that ‘Ryan’ is the salesperson of the first co-seller to ‘W-Mart’, ‘Keith’ is the salesperson of the second co-seller to ‘W-Mart’, and ‘Tom’ is the salesperson of the third co-seller to ‘W-Mart’.

In other embodiments, the data processing system described with reference to FIG. 3 may notify (340) the first salesperson (314) that the first salesperson (314) and the second salesperson (334) have the customer (306) in common by sending the first salesperson (314) an email informing the first salesperson (314) that the first salesperson (314) and the second salesperson (334) have the customer (306) in common. Alternatively, the data processing system described with reference to FIG. 3 may notify (340) the first salesperson (314) by sending the first salesperson (314) a text message or chat message to the first salesperson (314) stating that the first salesperson (314) and the second salesperson (334) have the customer (306) in common.

In some embodiments of managing vendor relationships in a co-seller network according to the present invention, vendors may want to limit which co-sellers in the network are able to see the customers served by that particular vendor. For example, a vendor might not want to disclose their customer list to a competitor. In other examples, a vendor may deem doing business as a co-seller with certain other vendors may not be desirable because of the poor quality of goods or services provided by those other vendors. Still further, a vendor may be contractually obligated to use certain vendors as co-sellers and unable to use other vendors for the same reasons. It may be advantageous, therefore, for vendors to have a list of authorized co-sellers that they work with that could be used by systems for managing vendor relationships in a co-seller network according to embodiments of the present invention.

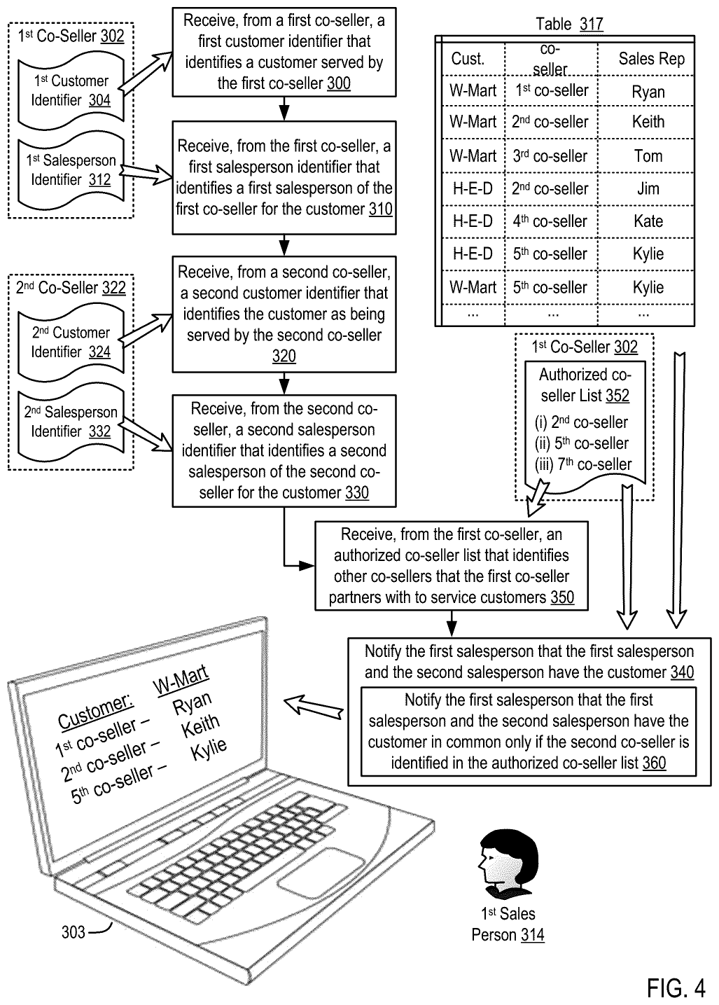

Turning to FIG. 4, FIG. 4 sets forth a flow chart illustrating another exemplary method for managing vendor relationships in a co-seller network according to embodiments of the present invention. The method of FIG. 4 operates similarly as described with reference to FIG. 3. The exemplary method of FIG. 4 operates on a data processing system that includes one or more processing units, a physical network interface coupled to the one or more processing units, and a non-volatile memory coupled to the one or more processing units. The non-volatile memory contains data structures and instructions that, when executed by a processing unit, carry out the steps shown in the example of FIG. 4.

In FIG. 4, the data processing system receives (300), from a first co-seller (302), a first customer identifier (304) that identifies a customer served by the first co-seller (302), receives (310), from the first co-seller (302), a first salesperson identifier (312) that identifies a first salesperson (314) of the first co-seller (302) for the customer, receives (320), from a second co-seller (322), a second customer identifier (324) that identifies the customer as being served by the second co-seller (322), and receives (330), from the second co-seller (322), a second salesperson identifier (332) that identifies a second salesperson (334) of the second co-seller (322) for the customer. The data processing system of FIG. 4 stores this customer information and salesperson information in table (317). Each row in table (317) represents the salesperson assigned by a co-seller to a particular customer.

In FIG. 4, the data processing system also receives (350), from the first co-seller (302), an authorized co-seller list (352) that identifies other co-sellers that the first co-seller (302) partners with to service customers. In FIG. 4, the authorized co-seller list (352) indicates that the first co-seller (302) is authorized to be in partnership and co-seller with: (i) the second co-seller, (ii) the fifth co-seller, and (iii) the seventh co-seller. The data processing system described with reference to FIG. 4 may receive (350) the authorized co-seller list (352) from the first co-seller (302) by providing an administrator for the first co-seller with the ability to upload a file—such as a CSV file, tab-delimited file, or flat file—with the list of authorized co-sellers for that vendor. In other embodiments, the data processing system described with reference to FIG. 4 may receive (350) the authorized co-seller list (352) from the first co-seller (302) by accessing the list of co-sellers in an internal database of that vendor using credentials supplied by that co-seller's administrator to the system.

In the example of FIG. 4, the data processing system notifies (340) the first salesperson (314) that the first salesperson (314) and the second salesperson (334) have the customer in common further by only notifying (360) the first salesperson (314) that the first salesperson (314) and the second salesperson (334) have the customer in common when the second co-seller (322) is identified in the authorized co-seller list (352). In the example of FIG. 4, therefore, the first salesperson (314) is notified that the first salesperson (314) has a customer in common with the second salesperson by creating a webpage within the data processing system and sending that webpage to a browser operating on laptop (303). The data processing system described with reference to FIG. 4 filters the data in table (317) to identify rows in the table (317) where the co-seller field in the table (317) matches with the first co-seller or one of the co-sellers listed in the authorized co-seller list. The data processing system described with reference to FIG. 4 further filters that information based on a particular customer of interest. So, in the example of FIG. 4, the first salesperson (314) is notified that the co-seller representatives of W-Mart are ‘Ryan’, ‘Keith’, and ‘Kylie’ for the first co-seller, the second co-seller, and the fifth co-seller.

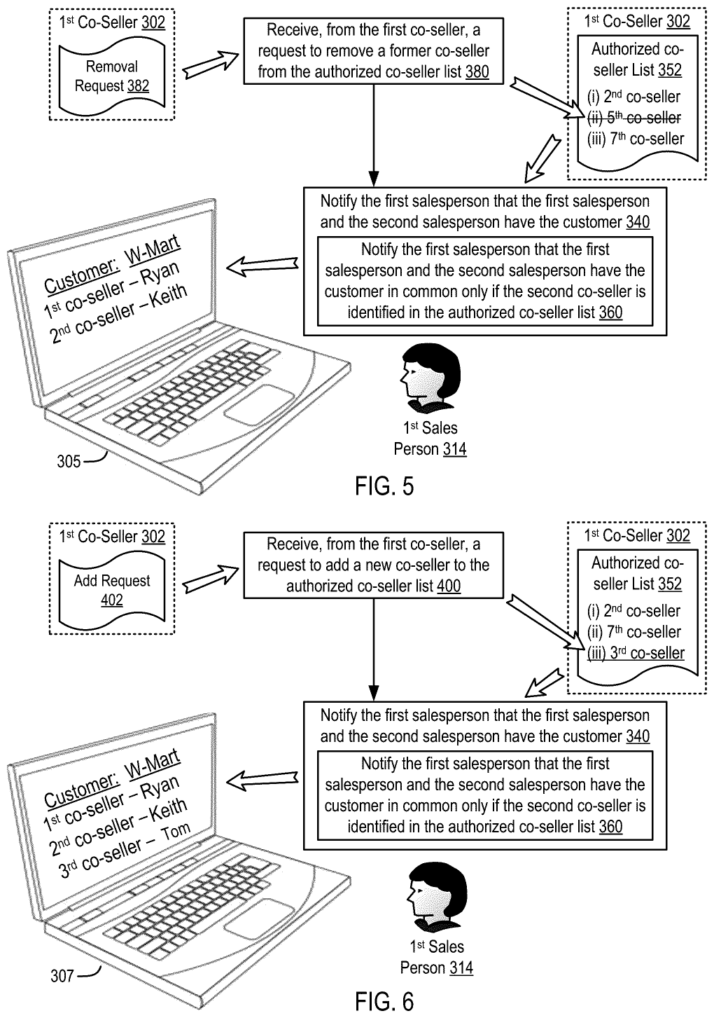

FIGS. 5 and 6 set forth flow charts illustrating exemplary methods for managing vendor relationships in a co-seller network according to embodiments of the present invention for removing and adding a co-seller to the authorized co-seller list described above. The systems of FIGS. 5 and 6 operate in a manner similar to the system described with reference to FIG. 4. In FIG. 5, however, the data processing system receives (380), from the first co-seller (302), a request (382) to remove a former co-seller from the authorized co-seller list (352). The request (382) of FIG. 5 may be a received from an administrator of the co-seller (302) through a user interface generated by the data processing system. Alternatively, the co-seller (302) may send a message to the data processing system to request removal of a co-seller that the data processing system parses to determine which co-seller to remove from the authorized co-seller list (130). Still further, to remove a former co-seller from the authorized co-seller list (352), the data processing system may simply receive a new list of authorized co-sellers from a vendor that just have the old vendor removed. Replacing the old authorized co-seller list with the new list would remove the former co-seller from the authorized co-seller list (130). In FIG. 5, the data processing system receives the request (382) to remove the fifth co-seller from the authorized co-seller list (352) and deletes the entry in the list (352) for the fifth co-seller.

In the example of FIG. 5, the data processing system then notifies (340) the first salesperson (314) that the first salesperson (314) and the second salesperson have the customer in common by only notifying (360) the first salesperson (314) that the first salesperson (314) and the second salesperson have the customer in common when the second co-seller is identified in the authorized co-seller list (352) in a manner similar to that described with reference to FIG. 4. In FIG. 5, the data processing system receives the request (382) to remove the fifth co-seller from the authorized co-seller list (352) and updates the user interface on laptop (305) to remove the reference to the fifth co-seller and the salesperson ‘Kylie’.

The data processing system of FIG. 6 receives (400), from the first co-seller (302), a request (402) to add a new co-seller to the authorized co-seller list (352). The request (402) to add a new co-seller may be received by the data processing system in a manner similar to the request (382) to remove a former co-seller from the list (352) described with reference to FIG. 5. In FIG. 6, the data processing system receives the request (402) to add the third co-seller to the authorized co-seller list (352) and makes a new entry in the list (352) for the third co-seller.

In the example of FIG. 6, the data processing system then notifies (340) the first salesperson (314) that the first salesperson (314) and the second salesperson have the customer in common by only notifying (360) the first salesperson (314) that the first salesperson (314) and the second salesperson have the customer in common when the second co-seller is identified in the authorized co-seller list (352). In FIG. 6, the data processing system receives the request (402) to add the third co-seller from the authorized co-seller list (352) and updates the user interface on laptop (307) to add the reference to the third co-seller and the salesperson ‘Tom’ based on the data in table (317) on FIG. 4.

In some embodiments of systems for managing vendor relationships in a co-seller network according to embodiments of the present invention, it may be advantageous to authenticate the identity of a salesperson attempting to use the exemplary system to find co-sellers for a particular customer. Authenticating a potential user's identity would keep a salesperson from claiming they work for a vendor of a customer just to obtain co-sellers' contact information.

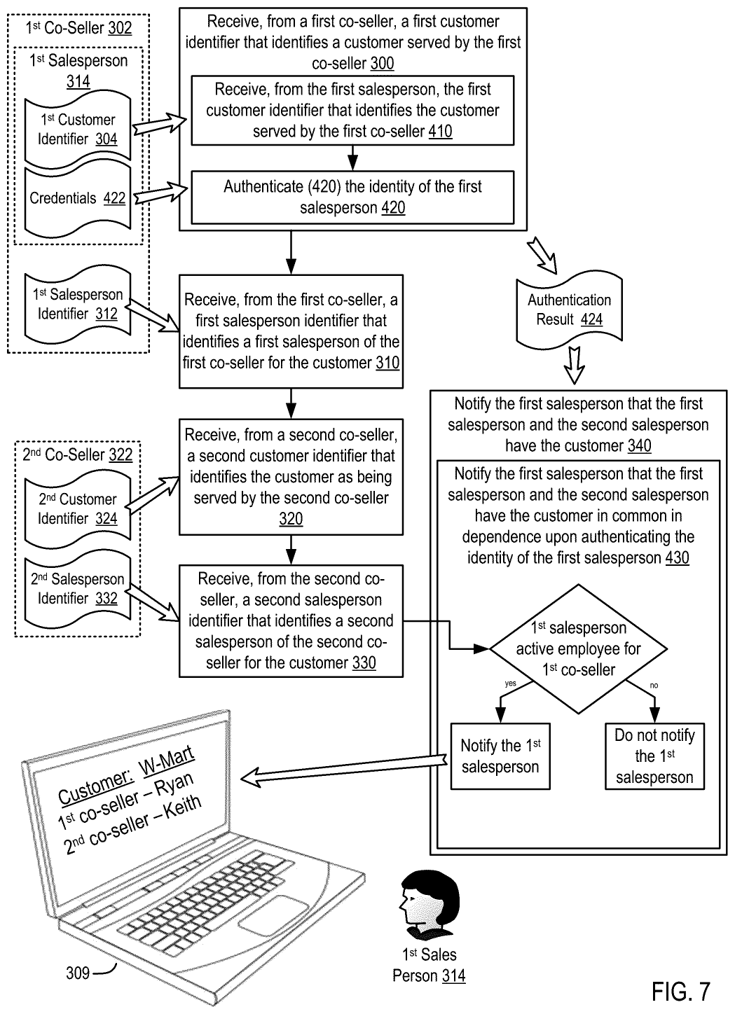

Turning to FIG. 7, FIG. 7 sets forth a flow chart illustrating another exemplary method for managing vendor relationships in a co-seller network according to embodiments of the present invention. The exemplary method for managing vendor relationships in a co-seller network in the example of FIG. 7 is similar to that exemplary method for managing vendor relationships in a co-seller network described with reference to FIG. 3. That is, the exemplary method of FIG. 3 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out: receiving (300), from a first co-seller (302), a first customer identifier (304) that identifies a customer (306) served by the first co-seller (302); receiving (310), from the first co-seller (302), a first salesperson identifier (312) that identifies a first salesperson (314) of the first co-seller (302) for the customer (306); receiving (320), from a second co-seller (322), a second customer identifier (324) that identifies the customer (306) as being served by the second co-seller (322); receiving (330), from the second co-seller (322), a second salesperson identifier (332) that identifies a second salesperson (334) of the second co-seller (322) for the customer (306); and notifying (340) the first salesperson (314) that the first salesperson (314) and the second salesperson (334) have the customer (306) in common in dependence upon the first customer identifier (304), the first salesperson identifier (312), the second customer identifier (324), and the second salesperson identifier (332).

In the example of FIG. 7, receiving (300), from the first co-seller (302), a first customer identifier (304) that identifies a customer served by the first co-seller (302) includes receiving (410), from the first salesperson (314), the first customer identifier (304) that identifies the customer (306) served by the first co-seller (302). The data processing system described with reference to FIG. 7 may receive (410) the first customer identifier (304) by providing the first salesperson (314) of the first co-seller (302) with a user interface that allows the salesperson to upload a CSV file with the identity of each of the customers of the first co-seller (302), by providing a user interface for the salesperson to manually type the names of the co-seller's (302) customers into the system, by accessing a list of customers from a co-seller's CRM system using API calls and credentials supplied by the sale co-seller's administrator or sales team, or any other manner as will occur those of skill in the art.

In the example of FIG. 7, receiving (300), from the first co-seller (302), a first customer identifier (304) that identifies a customer served by the first co-seller (302) also includes authenticating (420) the identity of the first salesperson (314). The data processing system described with reference to FIG. 7 may authenticate (420) the identity of the first salesperson (314) by receiving authentication credentials from the first salesperson (314). The authentication credentials may be implemented as a username and password combination, an email address, a unique employer identification card, and in other ways as will occur to those of skill in the art. The data processing system in the example of FIG. 7 may then determine that the first salesperson (314) is on a whitelist of authorized users for co-seller (302). In other embodiments, the data processing system described with reference to FIG. 7 may authenticate (420) the identity of the first salesperson (314) by determining that the salesperson (314) has a valid email address with the co-seller (302). Determining whether the salesperson (314) has a valid email address may be carried out by pinging the first co-seller's (302) company email server to find out whether the email address is active. In still other embodiments, the data processing system described with reference to FIG. 7 may authenticate (420) the identity of the first salesperson (314) by seeing whether the salesperson (314) is listed in the company's employee directory using API calls. When the data processing system for FIG. 7 authenticates the identify of the first salesperson (314), the data processing system obtains an authentication result (424). This authentication result could be implemented as a field in a database table, single byte or bit of data stored at a memory address for a file or buffer, a flag in a memory register, or any other data structure as will occur to those of skill in the art.

In FIG. 7, notifying (340) the first salesperson (314) that the first salesperson (314) and the second salesperson (334) have the customer (306) in common includes notifying (430) the first salesperson (314) that the first salesperson (314) and the second salesperson (334) have the customer (306) in common in dependence upon authenticating the identity of the first salesperson (314). That is, if the authentication result (424) indicates that the identity of the first salesperson (314) is authenticated, then the data processing system will notify (430) the first salesperson (314) that the first salesperson (314) and the second salesperson (334) have the customer (306) in common. If the authentication result (424) indicates that the identity of the first salesperson (314) is not authenticated, then the data processing system will not notify (430) the first salesperson (314) that the first salesperson (314) and the second salesperson (334) have the customer (306) in common. In the example of FIG. 7, the identify of salesperson (314) is authenticated, and the data processing system sends information to laptop (309) to display to user (314) that the sales representatives assigned by the first co-seller (302) and the second co-seller (322) for the common customer ‘W-Mart’ are ‘Ryan’ and ‘Keith,’ respectively.

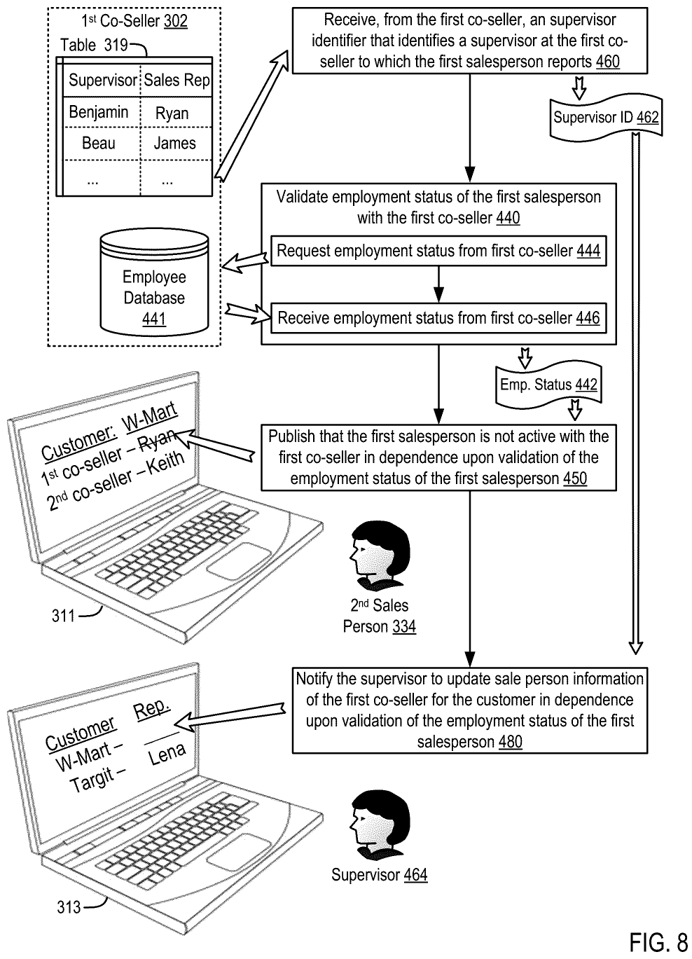

In FIG. 7, systems for managing vendor relationships in a co-seller network according to embodiments of the present invention including authenticating the identity of a salesperson. In the example of FIG. 8, readers of skill in the art will appreciate that it would be advantageous to also validate the employment status of a salesperson before sending them notifications regarding other parties in the co-seller network. FIG. 8, therefore, sets forth a flow chart illustrating another exemplary method for managing vendor relationships in a co-seller network according to embodiments of the present invention. The exemplary method for managing vendor relationships in a co-seller network in the example of FIG. 8 is similar to that exemplary method for managing vendor relationships in a co-seller network described with reference to FIG. 3. That is, the exemplary method of FIG. 3 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 8.

In the example of FIG. 8, the data processing system receives (460), from the first co-seller (302), a supervisor identifier (462) that identifies a supervisor at the first co-seller (302) to which the first salesperson (314) reports. The supervisor identifier (462) of FIG. 8 may be implemented as a employer ID number, social security number, full name, or some other way to unique identify the supervisor for the first salesperson. The data processing system of FIG. 8 may receive (460) a supervisor identifier (462) from the first co-seller (302) through a web page created to received manual input or an admin for the first co-seller (302) could upload a table (319) by sending the data processing system a CSV file with the table information. In the example of FIG. 8, table (319) indicates that ‘Benjamin’ is the supervisor for ‘Ryan’ and that ‘Beau’ is the supervisor for ‘James’.

The data processing system described with reference to FIG. 8 then validates (440) employment status (442) of the first salesperson (314) with the first co-seller (302). In FIG. 8, validating (440) employment status (442) of the first salesperson (314) with the first co-seller (302) may be carried out by requesting (444) employment status (442) from the employee database (441) of the first co-seller (302) and receiving (446) back the employment status (442) from the first co-seller (302). The data processing system of FIG. 8 may request and receive back the employment status (442) via a variety of messaging and/or API protocols.

In the example of FIG. 8, the data processing system publishes (450) that the first salesperson is not active with the first co-seller (302) in dependence upon validation of the employment status of the first salesperson. Publishing (450) that the first salesperson is not active with the first co-seller (302) according to the example of FIG. 8 may be carried out by reading the employment status (442) and if the first salesperson is no longer employed with the first co-seller (302), then generating a webpage with the first salesperson's contact information removed. For example, in FIG. 8, the salesperson ‘Ryan’ is no longer employed by the first cosellar (302) and, therefore, the data processing system of FIG. 8 removes him from the webpage viewed by the second salesperson (334) on laptop (311).

The data processing system of FIG. 8 then notifies (480) the supervisor (464) to update salesperson information of the first co-seller (302) for the customer in dependence upon validation of the employment status of the first salesperson (314) and the supervisor identifier (462). Notifying (480) the supervisor (464) to update salesperson information of the first co-seller (302) for the customer in the example of FIG. 8 may be carried out by emailing the supervisor that the first salesperson is not longer employed by the company and prompting the supervisor (464) to update the exemplary system of FIG. 8 when the supervisor logs into the system. For example, in FIG. 8, the supervisor (464) is prompted on a webpage with a blank line in the sales representative field for the ‘W-Mart’ customer served by the first co-seller (302) on laptop (313).

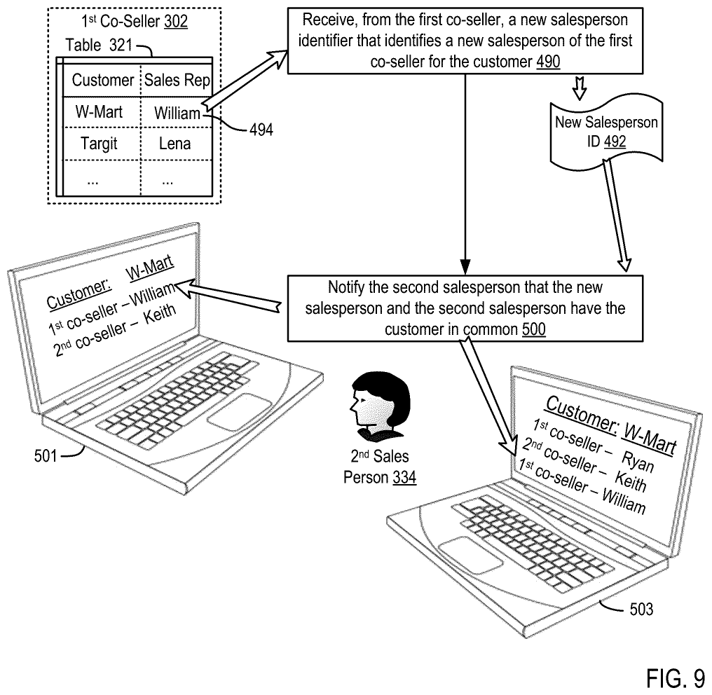

FIG. 9 sets forth a flow chart illustrating another exemplary method for managing vendor relationships in a co-seller network according to embodiments of the present invention where a new salesperson is assigned to a customer of a co-seller. The exemplary method for managing vendor relationships in a co-seller network in the example of FIG. 9 is similar to that exemplary method for managing vendor relationships in a co-seller network described with reference to FIG. 3. That is, the exemplary method of FIG. 9 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 9.

In FIG. 9, the data processing system receives (490), from the first co-seller (302), a new salesperson identifier (492) that identifies a new salesperson (494) of the first co-seller (302) for the customer. As previously mentioned, the data processing module may receive (490) the new salesperson identifier (492) in the example of FIG. 9 via entry on a webpage generated by the data processing system or by receiving the new salesperson identifier (492) as part of a CSV file uploaded to the data processing system. In the example of FIG. 9, the first co-seller (302) assigns the new salesperson (494) ‘William’ to the customer ‘W-Mart’ and stored that information in the company's database table (321). A copy of this table (321) is sent to the data processing system of FIG. 9.

The data processing system of FIG. 9 then notifies (500) the second salesperson (334) that the new salesperson (494) and the second salesperson (334) have the customer in common in dependence upon the first customer identifier, the new salesperson identifier (492), the second customer identifier, and the second salesperson identifier. The exemplary data processing system of FIG. 8 may carry out notifying (500) the second salesperson (334) by comparing the first customer identifier and the second customer identifier and finding matches. The data processing system may then look up the contact information for the second salesperson (334) using the second salesperson identifier and sending that second salesperson an email regarding the new salesperson, texting that second salesperson regarding the new salesperson, notifying the second salesperson with a message when he or she logs into the system the next time.

Depending on the request from the co-sellers (302) in the example of FIG. 9, the new salesperson may be replacing a former salesperson or just be a new addition to a larger team. In the example of FIG. 9, the laptop (501) shows the new salesperson ‘William’ replacing the prior salesperson ‘Ryan’ for the customer ‘W-Mart’. In contrast, the laptop (503) of FIG. 9 shows the new salesperson ‘William’ being added as a representative to the customer ‘W-Mart’ in addition to the current salesperson ‘Ryan’ for ‘W-Mart’.

In some embodiments, sales representatives may provide a list of co-sellers for which they want to be notified if a sales representative changes. Also, those sales representatives may also want to be notified when contacts for the customers they serve are changed or reassigned.

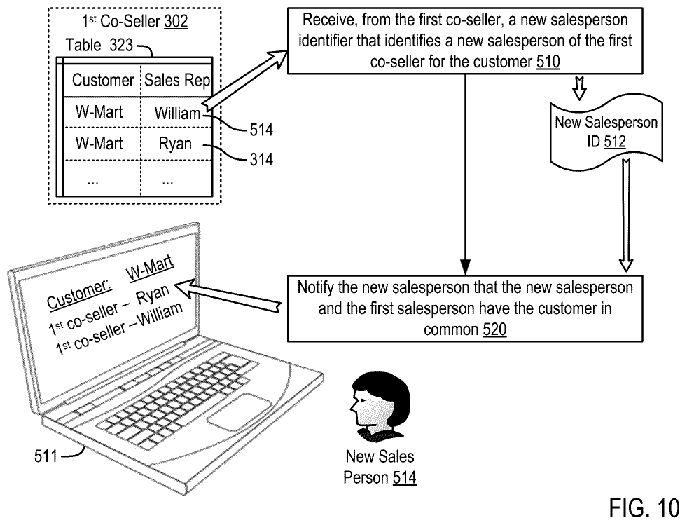

The exemplary method of FIG. 9 notified other co-sellers when a new sales representative was added to a co-seller. Turning to FIG. 10, FIG. 10 sets forth a flow chart illustrating another exemplary method for managing vendor relationships in a co-seller network according to embodiments of the present invention where a new salesperson is assigned to a customer and notified of other salespersons for the same co-seller that serve or have served that customer. The exemplary method for managing vendor relationships in a co-seller network in the example of FIG. 10 is similar to that exemplary method for managing vendor relationships in a co-seller network described with reference to FIG. 3. That is, the exemplary method of FIG. 10 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 10.

The data processing system of FIG. 10 receives (510), from the first co-seller (302), a new salesperson identifier (512) that identifies a new salesperson (514) of the first co-seller (302) for the customer (306). The data processing system in the example of FIG. 10 then notifying (520) the new salesperson (514) that the new salesperson (514) and the first salesperson (314) have the customer (306) in common in dependence upon the first customer identifier, the first salesperson identifier, and the new salesperson identifier (492). The data processing system of FIG. 10 carries out notifying (520) the new salesperson (514) by finding all the salesperson identifiers associated with the first customer identifier, retrieving contact information for all salespersons having been assigned to the customer identified by the first customer identifier. The data processing system of FIG. 10 may then email those other salespersons notifying them of the addition of the new salespersons or send them a message for when they log into the exemplary system of FIG. 10.

In the example of FIG. 10, a new sales representative (514) ‘William’ is added to the team that serves the customer ‘W-Mart’. And the data processing system of FIG. 10 updates the user interface on laptop (511) to information new salesperson (514) that both he and ‘Ryan’ were assigned to customer ‘W-Mart’. This enable ‘William’ to reach out to ‘Ryan’ to obtain institutional or specialized knowledge regarding customer ‘W-Mart’ that ‘Ryan’ may have obtained prior to ‘William’ coming on board.

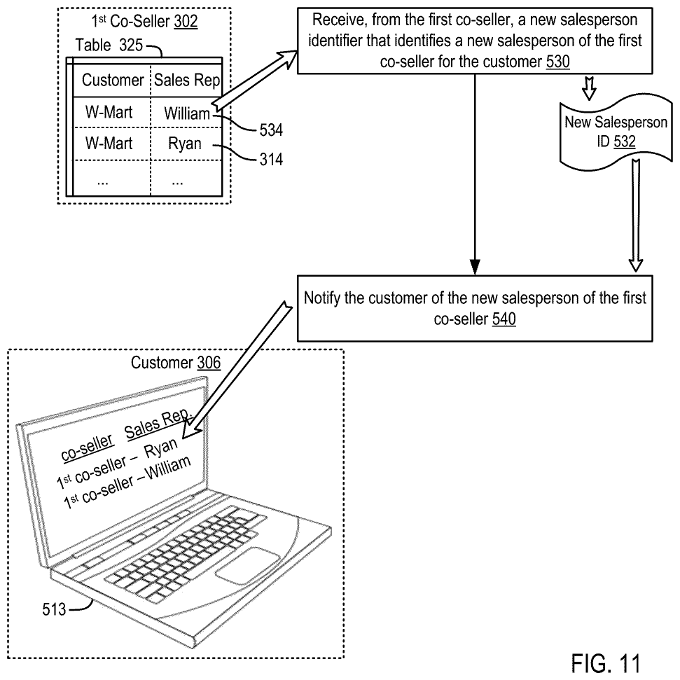

In addition to notify the new sales representative of other team members that may have been assigned to the same customer, readers will appreciate the advantages of notifying a customer when their salesperson changes for a particular vendor. Turning to FIG. 11, FIG. 11 sets forth a flow chart illustrating another exemplary method for managing vendor relationships in a co-seller network according to embodiments of the present invention. FIG. 11 is similar to that exemplary method for managing vendor relationships in a co-seller network described with reference to FIG. 3. That is, the exemplary method of FIG. 11 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 11.

In the example of FIG. 11, the data processing system of FIG. 11 receives (530), from the first co-seller (302), a new salesperson identifier (532) that identifies a new salesperson (534) of the first co-seller (302) for the customer (306) much in the same manner as described with reference to prior Figures. The first co-seller (302) includes a table (325) that stores information regarding the salespersons assigned to different customers of the first co-seller (302). The exemplary table (325) of FIG. 11 indicates that the current salesperson (314) ‘Ryan’ and the new salesperson (534) ‘William’ are both assigned to the customer ‘W-Mart’.

The data processing system of FIG. 11 also includes notify (540) the customer (306) of the new salesperson (534) of the first co-seller (302) in dependence upon the new salesperson identifier (532). The data processing system of FIG. 11 may notify (540) the customer (306) of the new salesperson (534) via email or via a message when a customer representative logs into the exemplary system according to the example of FIG. 11. In the example of FIG. 11, the data processing system notifies customer (306) that the new salesperson (534) ‘William’ has been added to the team of the first co-seller (302) that serves customer (306) by generating a webpage for display on laptop (513) that informs the customer (306) that ‘William’ has been added as an account representative.

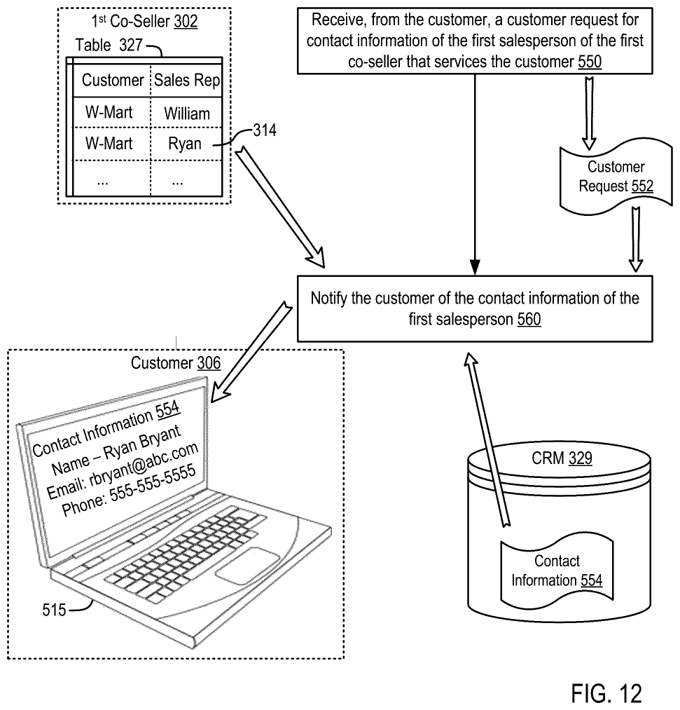

In the example of FIG. 11, the customer (306) is notified when a new salesperson is assigned to the customer's account with a vendor. Because of the churn of employee within a customer's organization, customer's would also benefit from being able to request the current contact information for their respective sales representatives at various strategic partners in a co-seller network. Turning to FIG. 12, FIG. 12 sets forth a flow chart illustrating an additional exemplary method for managing vendor relationships in a co-seller network according to embodiments of the present invention. FIG. 12 is similar to that exemplary method for managing vendor relationships in a co-seller network described with reference to FIG. 3. That is, the exemplary method of FIG. 12 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 12.

In the example of FIG. 12, the data processing system receives (550), from the customer (306), a customer request (552) for contact information (554) of the first salesperson (314) of the first co-seller (302) that services the customer (306). The data processing system of FIG. 12 may receive (550) a customer request (552) from the customer (306) for contact information (554) of the first salesperson (314) much in the same manner as described with reference to prior Figures. That is, the data processing system described with reference to FIG. 12 may receive (550) the customer request (552) in the form of an email or message through exemplary system via a messaging portal when a representative of the customer (306) logs into the exemplary system. Alternatively, the data processing system of FIG. 12 may receive (550) a customer request (552) from the customer (306) for contact information (554) of the first salesperson (314) when the customer's user of the exemplary system clicks on hyperlinks, buttons or various menu options on a user interface provided by the data processing system where the customer selects to view the current salespeople assigned to the customer (306) from each of the vendors that cosale to the customer in the co-seller network. The first co-seller (302) includes a table (327) that stores information regarding the salespersons assigned to different customers of the first co-seller (302). The exemplary table (327) of FIG. 12 indicates that the current salesperson (314) ‘Ryan’ and the new salesperson ‘William’ are both assigned to the customer ‘W-Mart’.

The data processing system of FIG. 12 then notifies (560) the customer (306) of the contact information (554) of the first salesperson (314). In the example of FIG. 12, the data processing system notifies (560) the customer (306) of the contact information (554) of the first salesperson (314) by accessing a CRM (329) for the first co-seller (302), retrieving the contact information (554) using the salesperson identifier for the first salesperson, and then publishing that contact information (554) on a webpage for display on laptop (515) used by the customer representative requesting the information. The data processing system of FIG. 12 provides the customer (306) with the name, email address, and phone number of the salesperson (314) that serves that customer (306).

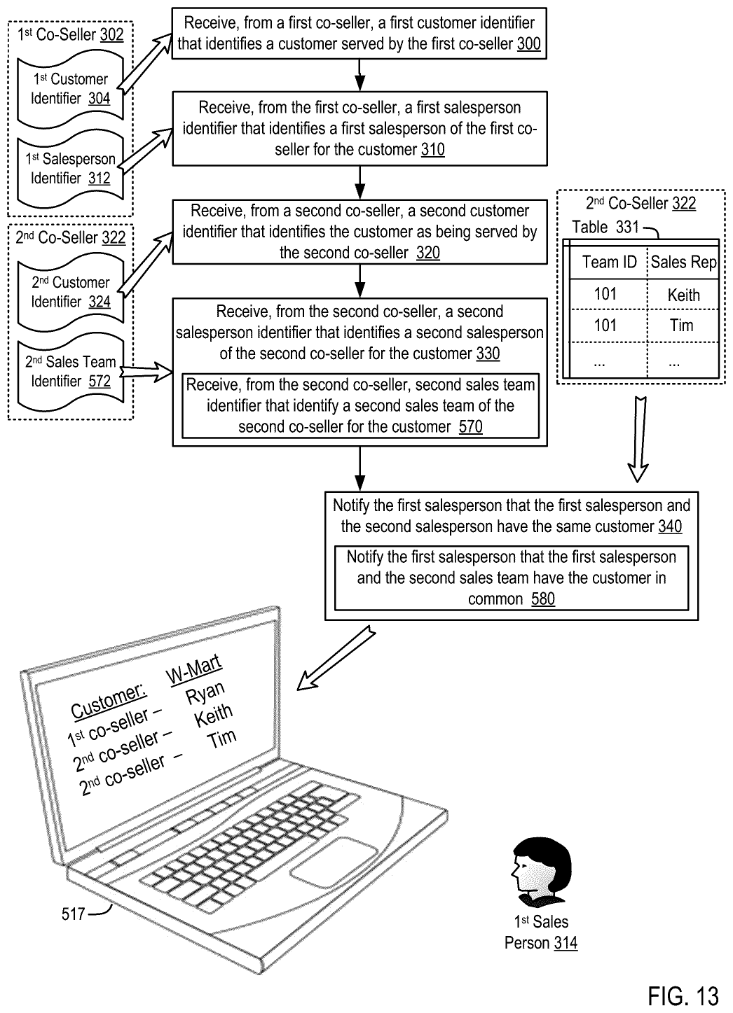

Often vendors will employ a team of people to support a salesperson in providing services to a particular customer. For example, a vendor might assemble a team of people having expertise in hardware, software, networking, finance, legal, integration, and so on to support a salesperson as they work to provide solutions for a customer. In these cases, it would be advantageous to make sure that other co-sellers in the vendor's co-seller network know all of the people on that team so they can coordinate with the right team member for a vendor in providing solutions to a common customer. FIG. 13, therefore, sets forth a flow chart illustrating an additional exemplary method for managing vendor relationships in a co-seller network according to embodiments of the present invention where a sales team is involved. FIG. 13 is similar to that exemplary method for managing vendor relationships in a co-seller network described with reference to FIG. 3. That is, the exemplary method of FIG. 13 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 13.

In the example of FIG. 13, the data processing system executes computer program instructions to carry out the following in a similar manner as FIG. 3: receiving (300), from a first co-seller (302), a first customer identifier (304) that identifies a customer served by the first co-seller (302); receiving (310), from the first co-seller (302), a first salesperson identifier (312) that identifies a first salesperson (314) of the first co-seller (302) for the customer; receiving (320), from a second co-seller (322), a second customer identifier (324) that identifies the customer as being served by the second co-seller (322); receiving (330), from the second co-seller (322), a second salesperson identifier that identifies a second salesperson of the second co-seller (322) for the customer; and notifying (340) the first salesperson (314) that the first salesperson (314) and the second salesperson have the customer in common in dependence upon the first customer identifier (304), the first salesperson identifier (312), the second customer identifier (324), and the second salesperson identifier.

The data processing system of FIG. 13 carries out receiving (330), from the second co-seller (322), a second salesperson identifier that identifies a second salesperson of the second co-seller (322) for the customer by receiving (570), from the second co-seller (322), second sales team identifier (572) that identify a second sales team of the second co-seller (322) for the customer (306). The data processing system of FIG. 13 may receive (570) the second sales team identifier (572) from the second co-seller (322) in a manner similar to the way the other exemplary data processing system described with reference to the Figures herein receive other team identifiers or salesperson identifiers. The second sales team identifier (572) is a unique piece of information that is used to identify an entire team of a vendor supporting the sale process. Each member of the team is assigned the same sales team identifier (572) to denote that they all belong to the same team. In the example of FIG. 13, the sales team identifier for the customer ‘W-Mart’ is ‘101’ and is stored in table (331). Table (331) of FIG. 13 indicates that the salespersons ‘Keith’ and ‘Tim’ are both on the sales team for ‘W-Mart’.

In the example of FIG. 13, notifying (340) the first salesperson (314) that the first salesperson (314) and the second salesperson (334) have the customer (306) in common includes notifying (580) the first salesperson (314) that the first salesperson (314) and the second sales team (574) have the customer (306) in common in dependence upon the second sales team identifier (572). The data processing system of FIG. 13 notifies (580) the first salesperson (314) that the first salesperson (314) and the second sales team have the customer (306) in common by using the second sales team identifier (572) to create a list of members of the second sales team from the information stored in table (331) and then generating a webpage for display on laptop (517) to the first sale person (314) that shows the first sale person (314) who all the members of the sales team are for the second co-seller (322). In other embodiments, the data processing system may share that team information with the first salesperson (314) via an email message, text message or message through an online portal of the exemplary system. As mentioned, table (331) of FIG. 13 indicates that the salespersons ‘Keith’ and ‘Tim’ are both on the sales team for ‘W-Mart’ for the second co-seller (322). Accordingly, the data processing system of FIG. 13 creates a webpage for the first salesperson (314) to see that both ‘Keith’ and ‘Tim’ are on the team of the second co-seller in the event that that the first salesperson (314) needs to contact them.

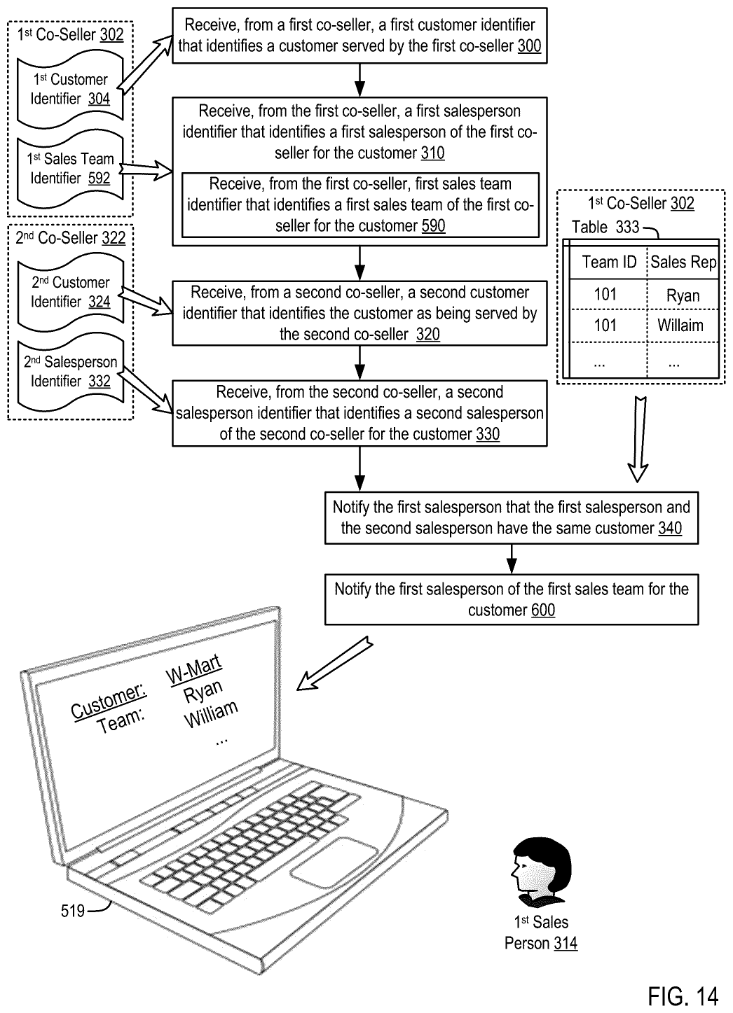

As discussed, sales representatives are typically supported by a team of other people at their company (e.g., hardware team member, software team member, networking team member, finance team member, legal team member) in an effort to provide solutions to customers. But often salespeople get moved around or change companies, and when that occurs, their support resources may get shifted and the salesperson is assigned to a new teams. Often, however, a salesperson wastes a lot of time trying to find out contact information for the various people on their support team. FIG. 14, therefore, sets forth a flow chart illustrating an additional exemplary method for managing vendor relationships in a co-seller network according to embodiments of the present invention that allows a salesperson to be notified regarding the members of their support team. FIG. 14 is similar to that exemplary method for managing vendor relationships in a co-seller network described with reference to FIG. 3. That is, the exemplary method of FIG. 14 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 14.

In the example of FIG. 14, the data processing system executes computer program instructions to carry out the following in a similar manner as FIG. 3: receiving (300), from a first co-seller (302), a first customer identifier (304) that identifies a customer served by the first co-seller (302); receiving (310), from the first co-seller (302), a first salesperson identifier that identifies a first salesperson (314) of the first co-seller (302) for the customer; receiving (320), from a second co-seller (322), a second customer identifier (324) that identifies the customer as being served by the second co-seller (322); receiving (330), from the second co-seller (322), a second salesperson identifier that identifies a second salesperson of the second co-seller (322) for the customer; and notifying (340) the first salesperson (314) that the first salesperson (314) and the second salesperson have the customer in common in dependence upon the first customer identifier (304), the first salesperson identifier, the second customer identifier (324), and the second salesperson identifier (332).

In the example of FIG. 14, receiving (310), from the first co-seller (302), a first salesperson identifier that identifies a first salesperson (314) of the first co-seller (302) for the customer includes receiving (590), from the first co-seller (302), first sales team identifier (592) that identifies a first sales team (594) of the first co-seller (302) for the customer (306). The data processing system of FIG. 14 may receive (590) the first sales team identifier (592) from the first co-seller (302) in a manner similar to the way the other exemplary data processing system described with reference to the Figures herein receive other team identifiers or salesperson identifiers. The sales team identifier (592) is a unique piece of information that is used to identify an entire team of a vendor supporting the sales process. Each member of the team is assigned the same sales team identifier (592) to denote that they all belong to the same team. In the example of FIG. 14, the sales team identifier for the customer ‘W-Mart’ is ‘101’ and is stored in table (333). Table (333) of FIG. 14 indicates that the salespersons ‘Ryan’ and ‘William’ are both on the sales team for ‘W-Mart’ for the first co-seller (302).

The exemplary data processing system of FIG. 14 notifies (600) the first salesperson (314) of the first sales team (594) for the customer (306) by using the first sales team identifier (592) to create a list of members of the first sales team from the information stored in table (333) and then generating a webpage for display on laptop (519) to the first sale person (314) that shows the first sale person (314) who all the members of the sales team are for the first co-seller (302). In other embodiments, the data processing system may share that team information with the first salesperson (314) via an email message, text message or message through an online portal of the exemplary system. As mentioned, table (333) of FIG. 14 indicates that the salespersons ‘Ryan’ and ‘William’ are both on the sales team for ‘W-Mart’ for the first co-seller (302). Accordingly, the data processing system of FIG. 14 creates a webpage for the first salesperson (314) to see that both ‘Ryan’ and ‘William’ are on the team of the first co-seller in the event that that the first salesperson (314) needs to contact them.

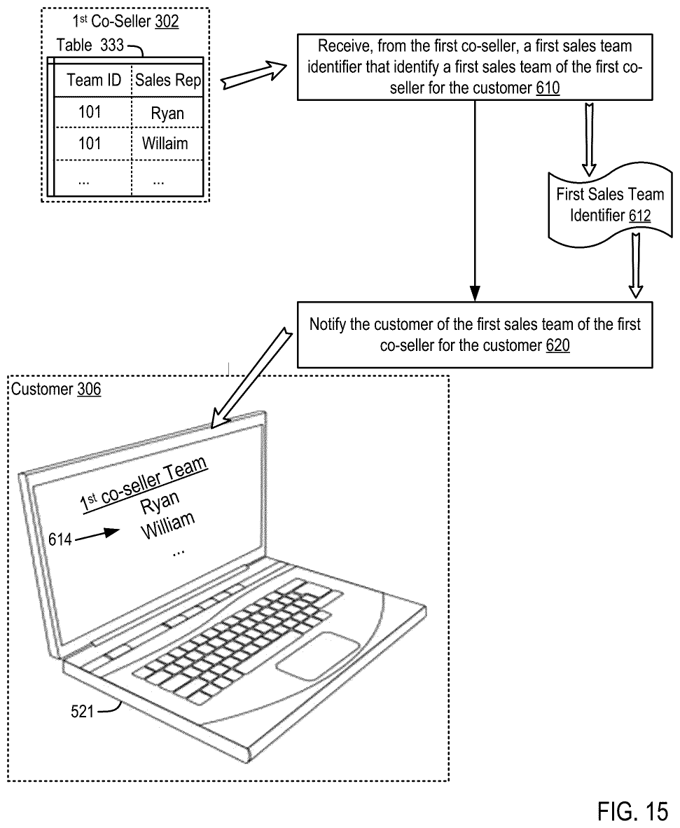

In addition to informing sales representatives of the contact information for their support teams within their own and each other's companies, readers will appreciate that it would be advantageous for customers to also receive information regarding the people on each salespersons supporting team. FIG. 15, therefore, sets forth a flow chart illustrating an additional exemplary method for managing vendor relationships in a co-seller network according to embodiments of the present invention that notify customers with information about various sales teams within a co-seller network. FIG. 15 is similar to that exemplary method for managing vendor relationships in a co-seller network described with reference to FIG. 3. That is, the exemplary method of FIG. 15 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 15.

In the example of FIG. 15, the data processing system receives (610), from the first co-seller (302), a first sales team identifier (612) that identify a first sales team (614) of the first co-seller (302) for the customer (306). The data processing system of FIG. 15 may receive (610) the first sales team identifier (612) from the first co-seller (302) in a manner similar to the way the other exemplary data processing system described with reference to the Figures herein receive other team identifiers or salesperson identifiers. The sales team identifier (612) is a unique piece of information that is used to identify an entire team of a vendor supporting the sales process. Each member of the team is assigned the same sales team identifier (612) to denote that they all belong to the same team. In the example of FIG. 15, the sales team identifier for the customer ‘W-Mart’ is ‘101’ and is stored in table (333). Table (333) of FIG. 15 indicates that the salespersons ‘Ryan’ and ‘William’ are both on the sales team for ‘W-Mart’ for the first co-seller (302).

The exemplary data processing system described with reference to FIG. 15 notifies (620) the customer (306) of the first sales team (614) of the first co-seller (302) for the customer (306) in dependence upon the first sales team identifier (612) by using the first sales team identifier (612) to create a list of members of the first sales team from the information stored in table (333) and then generating a webpage for display on laptop (521) to the customer (306) that shows the customer (306) who all the members of the sales team are for the first co-seller (302). In other embodiments, the data processing system may share that team information with the customer (306) via an email message, text message or message through an online portal of the exemplary system. As mentioned, table (333) of FIG. 15 indicates that the salespersons ‘Ryan’ and ‘William’ are both on the sales team for ‘W-Mart’ for the first co-seller (302). Accordingly, the data processing system of FIG. 15 creates a webpage for the customer (306) to see that both ‘Ryan’ and ‘William’ are on the team of the first co-seller in the event that that the customer (306) needs to contact them.

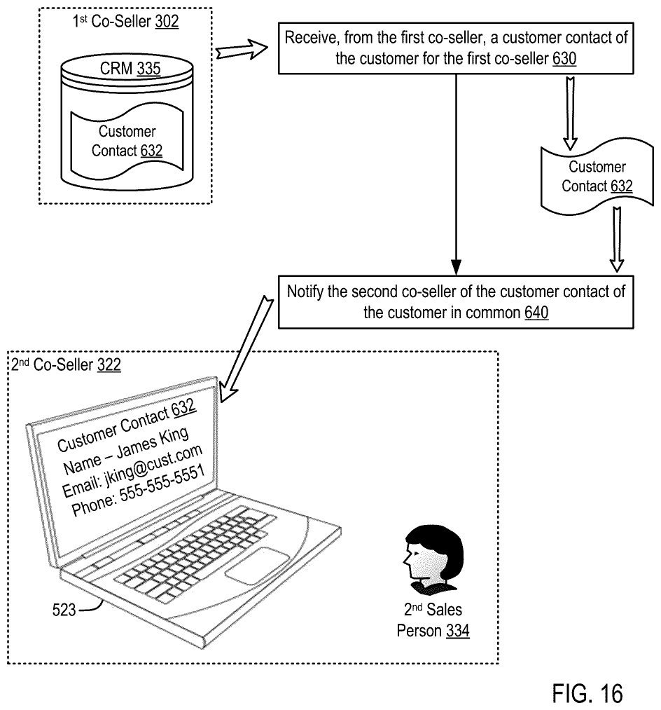

While the embodiment of the present invention described with reference to FIG. 15 is directed toward notifying a customer with information about a vendor's sales team, readers would appreciate that, as employee turnover and transfers occurs within a customer, it would be advantageous for a salesperson at a vendor to be notified when changes occur with their points of contact at their customer. FIG. 16 sets forth a flow chart illustrating an additional exemplary method for managing vendor relationships in a co-seller network according to embodiments of the present invention that shares contact information for customers among co-sellers. FIG. 16 is similar to that exemplary method for managing vendor relationships in a co-seller network described with reference to FIG. 3. That is, the exemplary method of FIG. 16 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 16.

In the example of FIG. 16, the data processing system receives (630), from the first co-seller (302), a customer contact (632) of the customer (306) for the first co-seller (302). The customer contact (632) of FIG. 16 is contact information for a representative at a customer of a vendor and includes information such as, for example, name, email, website, phone number, facsimile number, video conference URL, addresses, company title, and so on. The data processing system of FIG. 16 may receive (630) a customer contact (632) from the first co-seller (302) by retrieving the customer contact (632) from a CRM (335) of the first co-seller (302) using an API integration. Alternatively, the data processing system of FIG. 16 may receive (630) a customer contact (632) from the first co-seller (302) by providing a webpage for a salesperson at the first co-seller (302) to upload a CSV file with the customer contact information.

The data processing system described with reference to FIG. 16 notifies (640) the second co-seller (322) of the customer contact (632) of the customer (306) in common. In the example of FIG. 16, the data processing system may notify (640) the second co-seller (322) of the customer contact (632) by generating a webpage with the customer contact information and sending the webpage to a web browser executing on a laptop (523) of the second salesperson (334). Of course, those of skill in the art will recognize that the data processing system described with reference to FIG. 16 may notify (640) the second co-seller (322) of the customer contact (632) by email, text message, or through a messaging portal provided through a website generated by the data processing system.

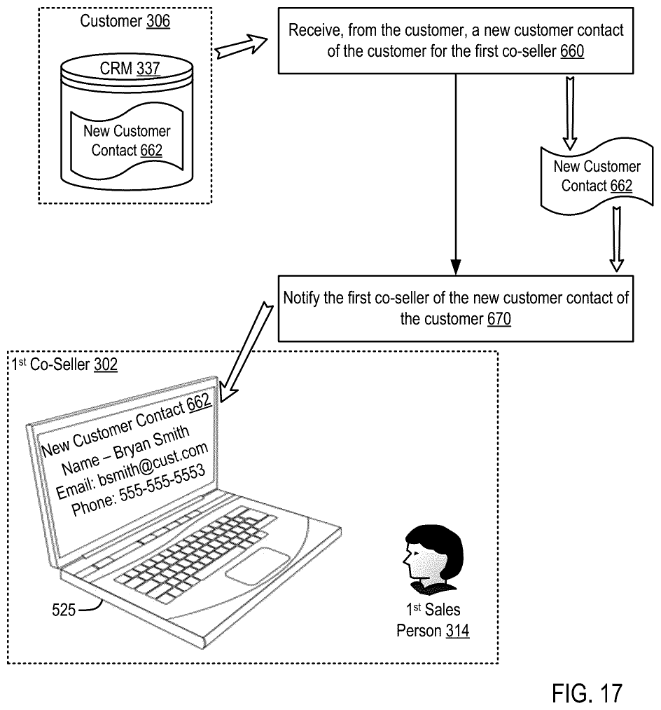

Turning to FIG. 17, FIG. 17 sets forth a flow chart illustrating an additional exemplary method for managing vendor relationships in a co-seller network according to embodiments of the present invention whereby a customer shares contact information for that customer to its co-sellers. FIG. 17 is similar to that exemplary method for managing vendor relationships in a co-seller network described with reference to FIG. 3. That is, the exemplary method of FIG. 17 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 17.

In the example of FIG. 17, the data processing system receives (660), from the customer (306), a new customer contact (662) of the customer (306) for the first co-seller (302). The data processing system described with reference to FIG. 17 may receive (660), from the customer (306), a new customer contact (662) by retrieving the new customer contact (662) from a CRM (337) of the customer (306) using an API integration. Alternatively, the data processing system of FIG. 16 may receive (660) the new customer contact (662) from the customer (306) by providing a webpage for a representative at the customer (306) to upload a CSV file with the new customer contact information.

The data processing system described with reference to FIG. 17 notifies (670) the first co-seller (302) of the new customer contact (662) of the customer (306). The data processing system described with reference to FIG. 17 may notify (670) the first co-seller (302) of the new customer contact (662) by generating a webpage with the customer contact information and sending the webpage to a web browser executing on a laptop (525) of the first salesperson (314). Of course, those of skill in the art will recognize that the data processing system described with reference to FIG. 17 may notify (670) the first co-seller (302) of the new customer contact (662) by email, text message, or through a messaging portal provided through a website generated by the data processing system.

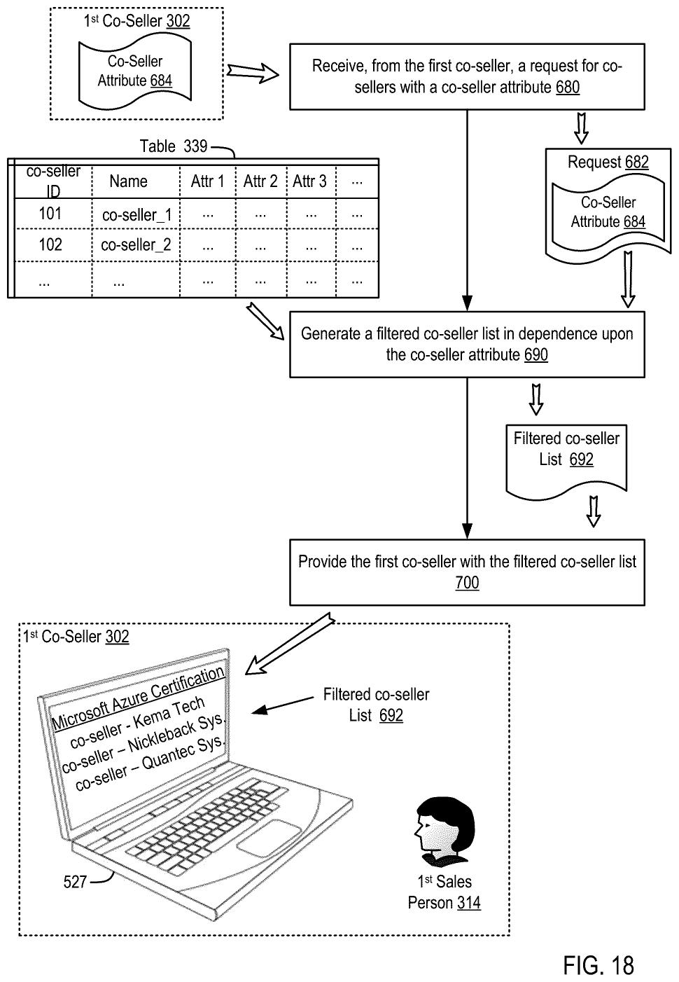

Often a salesperson is looking to establish strategic partnerships with other co-sellers that have product or service offerings that complement the solutions offered by the salesperson's company. For example, a hardware vendor may seek a strategic partnership with a vendor that provides software solutions and specially need a software solution partner that is certified on a particular software platform or is located in a specific geographic region. FIG. 18 sets forth a flow chart illustrating an additional exemplary method for managing vendor relationships in a co-seller network according to embodiments of the present invention where a salesperson can search for co-sellers with certain attributes. FIG. 18 is similar to that exemplary method for managing vendor relationships in a co-seller network described with reference to FIG. 3. That is, the exemplary method of FIG. 18 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 18.

In the example of FIG. 18, the data processing system receives (680), from the first co-seller (302), a request (682) for co-sellers with a co-seller attribute (684). The co-seller attribute (684) of FIG. 18 is characteristic of a co-seller that describes certain features or qualities of the co-seller. Examples of co-seller attributes (684) useful in FIG. 18 may includes but are not limited to certifications held by a co-seller or by the people working for the co-seller, geography covered by the a co-seller, location of offices a co-seller, languages in which a co-seller can conduct business, and so on. The data processing system described with reference to FIG. 18 may receive (680) a request (682) from the first co-seller (302) for co-sellers with the co-seller attribute (684) by: generating a webpage that presents an interface through which a first co-seller (302) can navigate and select from a list of attribute types the attribute types that the co-seller (302) is interested in using to find a strategic partnership, collect the user input for the values of interest to the co-seller (302) for each of the selected attribute types. For example, a salesperson may be interested in searching for co-sellers based on certifications that the co-seller has such as a Microsoft Azure Certification, Certified Partner for Oracle, Google Cloud Certification, and so on.

In the example of FIG. 18, the data processing system then generates (690) a filtered co-seller list (692) in dependence upon the co-seller attribute (684). The data processing system described with reference to FIG. 18 may generate (690) a filtered co-seller list (692) by searching a table (339) for rows that have attribute values matching those specified by the first co-seller (302) and adding the co-seller identifiers for those matching rows to the filtered co-seller list (692). Each row in the table (339) of FIG. 18 represents a co-seller in the co-seller network. The columns of table (339) in FIG. 18 include a ‘Co-seller ID’ field, ‘Name’ field, and various Attribute fields. The ‘Co-seller ID’ field stores the unique identifier for each co-seller within the co-seller network. The ‘Name’ field stores the name of the co-seller. And each attribute column represent a particular attribute type.

In the example of FIG. 18, the data processing system then provides (700) the first co-seller (302) with the filtered co-seller list (692). The data processing system of FIG. 18 may provide (700) the first co-seller (302) with the filtered co-seller list (692) by generating a webpage with information about the co-sellers included in the filtered co-seller list (692) and sending that webpage to a laptop (527) of the first salesperson (314) for display by a web browser operating on the laptop (527). In the example of FIG. 18, the filtered co-seller list (692) provides the first salesperson (314) with a list of co-sellers that have Microsoft Azure Certification and the list (692) includes ‘Kema Technologies’, ‘Nickleback Systems’, and ‘Quantec Systems’.

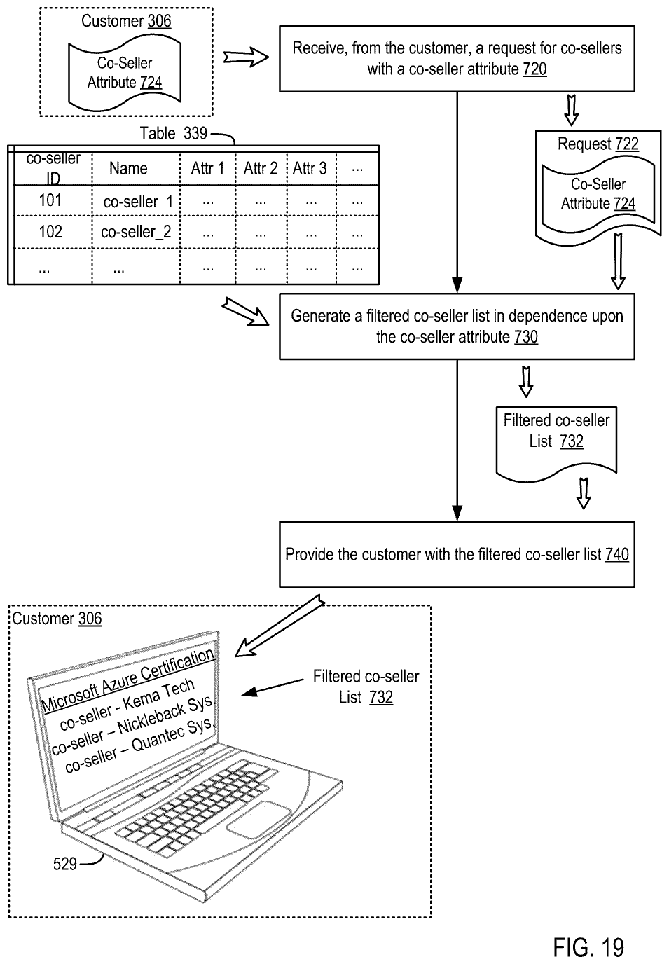

Salespersons are not the only users that will appreciate the ability to search for co-sellers by some attribute type—customers will also find this capability useful. Turning to FIG. 19, FIG. 19 sets forth a flow chart illustrating an additional exemplary method for managing vendor relationships in a co-seller network according to embodiments of the present invention. FIG. 19 is similar to that exemplary method for managing vendor relationships in a co-seller network described with reference to FIG. 18. That is, the exemplary method of FIG. 19 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 19.

In the example of FIG. 19, the data processing system includes receiving (720), from the customer (306), a request (722) for co-sellers with a co-seller attribute (724) that operates in a similar fashion as described with reference to FIG. 18 where the first co-seller is providing the request. The data processing system described with reference to FIG. 19 also includes generating (730) a filtered co-seller list (732) in dependence upon the co-seller attribute (724) that operates in a manner similar to the example of FIG. 18. The data processing system described with reference to FIG. 19 also includes providing (740) the customer (306) with the filtered co-seller list (732) that also operates in a manner similar to the example of FIG. 18. And in the example of FIG. 19, the filtered co-seller list (732) provides the customer (306) with a list of co-sellers on laptop (529) that have Microsoft Azure Certification—‘Kema Technologies’, ‘Nickleback Systems’, and ‘Quantec Systems’.

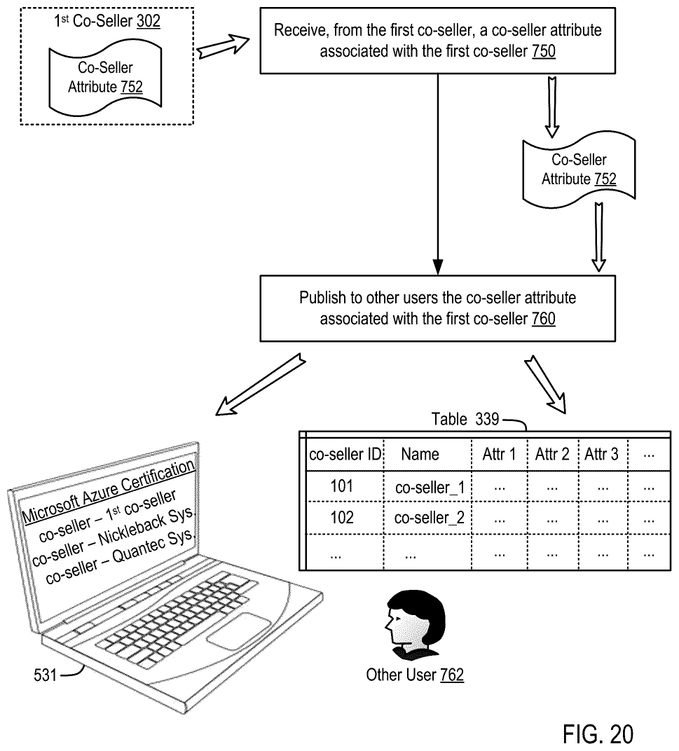

Co-sellers are typically able to update their co-seller attributes as co-seller characteristics change. For example, a co-seller may expand into a new territory, obtain a new certification, take on an additional product or service offering. FIG. 20, therefore, sets forth a flow chart illustrating an additional exemplary method for managing vendor relationships in a co-seller network according to embodiments of the present invention. FIG. 20 is similar to that exemplary method for managing vendor relationships in a co-seller network described with reference to FIGS. 18 and 19. That is, the exemplary method of FIG. 20 is implemented using data processing system with one or more processing units operatively coupled to a physical network interface. The data processing system includes a non-volatile memory coupled to the one or more processing units. The non-volatile memory contains a data structure and instructions, and the one or more processing units are configured to cause execution of the instructions for carrying out the method of FIG. 20.

In the example of FIG. 20, the data processing system receives (750), from the first co-seller (302), a co-seller attribute (752) associated with the first co-seller (302). The data processing system described with reference to FIG. 20 may receive (750) a co-seller attribute (752) associated with the first co-seller (302) by generating a webpage that presents an interface through which a first co-seller (302) can navigate and select from a list of attribute types the attribute that the co-seller (302) desires to add regarding itself so that other users of the co-seller network search for the co-seller (302) based on this characteristic.

In the example of FIG. 20, the data processing system then publishes (760) to other users (762) the co-seller attribute (752) associated with the first co-seller (302). The data processing system described with reference to FIG. 20 then publishes (760) to other users (762) the co-seller attribute (752) by entering that co-seller attribute (752) into the table (339) so it is available to be searched according to other embodiments described with reference to FIGS. 18 and 19. In the alternative, the data processing system described with reference to FIG. 20 may publish (760) to other users (762) the co-seller attribute (752) by generating a webpage and sending that webpage to a laptop (531) for display to other users (762) with a web browser operating on the laptop (531).

Exemplary embodiments of the present invention are described largely in the context of fully functional data processing systems for managing vendor relationships in a co-seller network according to embodiments of the present invention. Readers of skill in the art will recognize, however, that portions of the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, flash storage, magnetoresistive storage, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A system for managing vendor relationships in a co-seller network, the system comprising:
one or more processing units;
a physical network interface coupled to the one or more processing units;
a non-volatile memory coupled to the one or more processing units, the non-volatile memory containing a data structure and instructions, the one or more processing units configured to cause execution of the instructions for carrying out:
receiving, from a first co-seller, a first customer identifier that identifies a customer served by the first co-seller;
receiving, from the first co-seller, a first salesperson identifier that identifies a first salesperson of the first co-seller for the customer;
receiving, from a second co-seller, a second customer identifier that identifies the customer as being served by the second co-seller;
receiving, from the second co-seller, a second salesperson identifier that identifies a second salesperson of the second co-seller for the customer; and
notifying the first salesperson that the first salesperson and the second salesperson have the customer in common in dependence upon the first customer identifier, the first salesperson identifier, the second customer identifier, and the second salesperson identifier.

2. The system of claim 1 wherein:
the one or more processing units are configured to cause execution of the instructions for carrying out:
receiving, from the first co-seller, an authorized co-seller list that identifies other co-sellers that the first co-seller partners with to service customers; and
notifying the first salesperson that the first salesperson and the second salesperson have the customer in common further comprises notifying the first salesperson that the first salesperson and the second salesperson have the customer in common only if the second co-seller is identified in the authorized co-seller list.

3. The system of claim 2 wherein:
the one or more processing units are configured to cause execution of the instructions for carrying out:
receiving, from the first co-seller, a request to add a new co-seller to the authorized co-seller list.

4. The system of claim 2 wherein:
the one or more processing units are configured to cause execution of the instructions for carrying out:
receiving, from the first co-seller, a request to remove a former co-seller from the authorized co-seller list.

5. The system of claim 1 wherein:
receiving, from a first co-seller, a first customer identifier that identifies a customer served by the first co-seller further comprises:
receiving, from the first salesperson, the first customer identifier that identifies the customer served by the first co-seller,
authenticating the identity of the first salesperson; and
notifying the first salesperson that the first salesperson and the second salesperson have the customer in common further comprises notifying the first salesperson that the first salesperson and the second salesperson have the customer in common in dependence upon authenticating the identity of the first salesperson.

6. The system of claim 1 wherein:
the one or more processing units are configured to cause execution of the instructions for carrying out:
validating employment status of the first salesperson with the first co-seller; and
publishing that the first salesperson is not active with the first co-seller in dependence upon validation of the employment status of the first salesperson.

7. The system of claim 6 wherein:
the one or more processing units are configured to cause execution of the instructions for carrying out:
receiving, from the first co-seller, a supervisor identifier that identifies a supervisor at the first co-seller to which the first salesperson reports; and
notifying the supervisor to update salesperson information of the first co-seller for the customer in dependence upon validation of the employment status of the first salesperson and the supervisor identifier.

8. The system of claim 1 wherein:
the one or more processing units are configured to cause execution of the instructions for carrying out:
receiving, from the first co-seller, a new salesperson identifier that identifies a new salesperson of the first co-seller for the customer; and
notifying the second salesperson that the new salesperson and the second salesperson have the customer in common in dependence upon the first customer identifier, the new salesperson identifier, the second customer identifier, and the second salesperson identifier.

9. The system of claim 1 wherein:
the one or more processing units are configured to cause execution of the instructions for carrying out:
receiving, from the first co-seller, a new salesperson identifier that identifies a new salesperson of the first co-seller for the customer; and
notifying the new salesperson that the new salesperson and the first salesperson have the customer in common in dependence upon the first customer identifier, the first salesperson identifier, and the new salesperson identifier.

10. The system of claim 1 wherein:
the one or more processing units are configured to cause execution of the instructions for carrying out:
receiving, from the first co-seller, a new salesperson identifier that identifies a new salesperson of the first co-seller for the customer; and
notifying the customer of the new salesperson of the first co-seller in dependence upon the new salesperson identifier.

11. The system of claim 1 wherein:
the one or more processing units are configured to cause execution of the instructions for carrying out:
receiving, from the customer, a customer request for contact information of the first salesperson of the first co-seller that services the customer; and
notifying the customer of the contact information of the first salesperson.

12. The system of claim 1 wherein:
receiving, from the second co-seller, a second salesperson identifier that identifies a second salesperson of the second co-seller for the customer further comprises receiving, from the second co-seller, second sales team identifier that identify a second sales team of the second co-seller for the customer; and
notifying the first salesperson that the first salesperson and the second salesperson have the customer in common further comprises notifying the first salesperson that the first salesperson and the second sales team have the customer in common in dependence upon the second sales team identifier.

13. The system of claim 1 wherein:
receiving, from the first co-seller, a first salesperson identifier that identifies a first salesperson of the first co-seller for the customer further comprises receiving, from the first co-seller, first sales team identifier that identifies a first sales team of the first co-seller for the customer; and
the one or more processing units are configured to cause execution of the instructions for carrying out:
notifying the first salesperson of the first sales team for the customer.

14. The system of claim 1 wherein the one or more processing units are configured to cause execution of the instructions for carrying out:
receiving, from the first co-seller, a first sales team identifier that identify a first sales team of the first co-seller for the customer; and
notifying the customer of the first sales team of the first co-seller for the customer in dependence upon the first sales team identifier.

15. The system of claim 1 wherein the one or more processing units are configured to cause execution of the instructions for carrying out:
receiving, from the first co-seller, a customer contact of the customer for the first co-seller; and
notifying the second co-seller of the customer contact of the customer in common.

16. The system of claim 1 wherein the one or more processing units are configured to cause execution of the instructions for carrying out:
receiving, from the customer, a new customer contact of the customer for the first co-seller; and
notifying the first co-seller of the new customer contact of the customer.

17. The system of claim 1 wherein the one or more processing units are configured to cause execution of the instructions for carrying out:
receiving, from the first co-seller, a request for co-sellers with a co-seller attribute;
generating a filtered co-seller list in dependence upon the co-seller attribute; and
providing the first co-seller with the filtered co-seller list.

18. The system of claim 1 wherein the one or more processing units are configured to cause execution of the instructions for carrying out:
receiving, from the customer, a request for co-sellers with a co-seller attribute;
generating a filtered co-seller list in dependence upon the co-seller attribute; and
providing the customer with the filtered co-seller list.

19. The system of claim 1 wherein the one or more processing units are configured to cause execution of the instructions for carrying out:
receiving, from the first co-seller, a co-seller attribute associated with the first co-seller; and
publishing to other users the co-seller attribute associated with the first co-seller.

20. A computer-implemented method for managing vendor relationships in a co-seller network, the method comprising:
receiving, from a first co-seller, a first customer identifier that identifies a customer served by the first co-seller;
receiving, from the first co-seller, a first salesperson identifier that identifies a first salesperson of the first co-seller for the customer;
receiving, from a second co-seller, a second customer identifier that identifies the customer as being served by the second co-seller,
receiving, from the second co-seller, a second salesperson identifier that identifies a second salesperson of the second co-seller for the customer; and
notifying the first salesperson that the first salesperson and the second salesperson have the customer in common in dependence upon the first customer identifier, the first salesperson identifier, the second customer identifier, and the second salesperson identifier.
